(19) United States
(12) Patent Application Publication
(10) Pub. No.: US 2015/0239179 A1
(43) Pub. Date: Aug. 27, 2015

(54) APPARATUS FOR MANUFACTURING THREE-DIMENSIONAL SHAPED OBJECT, METHOD OF MANUFACTURING THREE-DIMENSIONAL SHAPED OBJECT, AND THREE-DIMENSIONAL SHAPED OBJECT

(71) Applicant: SEIKO EPSON CORPORATION, Tokyo (JP)

(72) Inventors: Junichi GOTO, Matsumoto (JP); Eiji OKAMOTO, Matsumoto (JP)

(21) Appl. No.: 14/625,063

(22) Filed: Feb. 18, 2015

(30) Foreign Application Priority Data
Feb. 24, 2014 (JP) 2014-032578

(51) Int. Cl. B29C 67/00; B22F 3/105; B28B 1/00; B22F 3/00

(52) U.S. Cl. CPC B29C 67/0092; B22F 3/008; B22F 3/1055; B29C 67/0081; B28B 1/001; B29C 67/0085; B22F 2003/1058; B29K 2105/251

(57) ABSTRACT

An apparatus for manufacturing a three-dimensional shaped object manufactures a three-dimensional shaped object by using a composition in paste form including particles to successively lay down layers, and has a stage where the composition is applied and where the layers are formed, and a side surface support part arranged at a side surface of the stage. The stage and the side surfaces support part are configured and arranged so that the stage moves relative to the side surface support part in a direction of layering of the layers. At least a part of the side surface support part is spaced apart from the side surface of the stage when the stage is moving relative to the side surface support part in the direction of layering of the layers.

### CROSS-REFERENCE TO RELATED APPLICATIONS

This application claims priority to Japanese Patent Application No. 2014-032578 filed on Feb. 24, 2014. The entire disclosure of Japanese Patent Application No. 2014-032578 is hereby incorporated herein by reference.

### BACKGROUND

1. Technical Field

The present invention relates to an apparatus for manufacturing a three-dimensional shaped object, a method of manufacturing a three-dimensional shaped object, and a three-dimensional shaped object.

2. Related Art

There is a known technique for shaping a three-dimensional shaped object by using a composition that comprises a powder (particles) to form material layers (unit layers) and successively lay these material layers down (for example, see Japanese Laid-Open Patent Publication No. 2003-53847). In this technique, the three-dimensional shaped object is shaped by repeating the following operation. First the powder is spread thin at uniform thickness to form a material layer, and the powder is made to selectively bind to itself only at a desired portion of the material layer, thus forming a binding part. As a result of this, a thin, planar member (hereinafter referred to as a “cross-section member”) is formed at the binding part where the powder has bound to itself. Thereafter, another material layer is formed thin on that material layer, and the powder is selectively made to bind to itself at only a desired portion, thus forming a binding part. As a result, a new cross-section member is formed also on the newly formed material layer. At this time, the newly formed cross-section member is also bound to the previously formed cross-section member. Repeating such an operation to successively lay the thin, planar cross-section members (binding parts) down one layer at a time makes it possible to shape the three-dimensional shaped object.

In such a method, the composition used is in some instances in paste form that comprises a component (liquid component) taking a liquid form during the material layer formation, for such purposes as raising the fluidity of the composition to improve the workability during formation of the material layers, or preventing unintended scattering or the like of the powder during the material layer formation.

With the technique of such description, however, the material layers have in some instances suffered a disturbance when a stage on which the material layers have been formed is being lowered for when the new material is being formed. In such a case, the resulting three-dimensional shaped object has defects or has poor dimensional accuracy. In some cases, even the manufacture itself of the three-dimensional shaped object may become impossible.

### SUMMARY

A purpose of the present invention is to provide an apparatus for manufacturing a three-dimensional shaped object enabling the efficient manufacture of a three-dimensional shaped object which has excellent dimensional accuracy and with which the occurrence of defects has been effectively prevented, a method of manufacturing a three-dimensional shaped object enabling the efficient manufacture of a three-dimensional shaped object which has excellent dimensional accuracy and with which the occurrence of defects has been effectively prevented, and a three-dimensional shaped object manufactured using the aforementioned apparatus for manufacturing a three-dimensional shaped object and the aforementioned method of manufacturing a three-dimensional shaped object.

Such objectives are achieved by aspects of the present invention described below.

An apparatus for manufacturing a three-dimensional shaped object according to one aspect is adapted to manufacture a three-dimensional shaped object by successively laying down layers using a composition in paste form including particles. The apparatus for manufacturing a three-dimensional shaped object includes a stage and a side surface support part. The stage is where the composition is applied and where the layers are formed. The side surface support part is arranged at a side surface of the stage. The stage and the side surface support part are configured and arranged so that the stage moves relative to the side surface support part in a direction of layering of the layers, at least a part of the side surface support part being spaced apart from the stage when the stage is moving relative to the side surface support part in the direction of layering of the layers.

This makes it possible to provide an apparatus for manufacturing a three-dimensional shaped object enabling the efficient manufacture of a three-dimensional shaped object which has excellent dimensional accuracy and with which the occurrence of defects has been effectively prevented.

In the apparatus for manufacturing a three-dimensional shaped object, preferably, the stage is preferably configured and arranged to move in the direction of layering of the layers.

This makes it possible to simplify the configuration of the apparatus for manufacturing a three-dimensional shaped object.

In the apparatus for manufacturing a three-dimensional shaped object, preferably, the side surface support part is preferably configured and arranged to move in the direction of layering of the layers.

This makes it possible to suitably manufacture the three-dimensional shaped object even in a case where, for example, the stage has a large surface area, or the three-dimensional shaped object that needs to be manufactured weights a considerable amount.

Preferably, the apparatus for manufacturing a three-dimensional shaped object is provided with a flattening part configured and arranged to move over the stage in a manner relative to the stage and to flatten the composition applied to the stage to form the layers. A portion of the side surface support part arranged on both sides of a first direction, which is a relative movement direction of the flattening part, is preferably spaced apart from side surfaces of the layers.

This makes it possible to more effectively prevent the occurrence if defects in the three-dimensional shaped object being manufactured, and makes it possible to impart particularly excellent dimensional accuracy to the three-dimensional shaped object being manufactured.

In the apparatus for manufacturing a three-dimensional shaped object, preferably, a portion of the side surface support part arranged on both sides of a second direction orthogonal to the first direction is also spaced apart from the side surfaces of the layers.

This makes it possible to even more effectively prevent the occurrence of defects in the three-dimensional shaped object being manufactured, and possible to give the three-dimensional shaped object being manufactured even more excellent dimensional accuracy.

Preferably, the apparatus for manufacturing a three-dimensional shaped object is provided with a heating part configured and arranged to heat the side surface support part.

This makes it possible to effectively prevent the layers from sticking to the side surface support part, and makes it possible to more reliably prevent the layers from experiencing unintended deformation (disturbance).

Preferably, the apparatus for manufacturing a three-dimensional shaped object is provided with a binder solution applying part configured and arranged to apply a binder solution for binding the particles.

This makes it possible to easily and reliably endow the three-dimensional shaped object with excellent mechanical strength.

Preferably, the apparatus for manufacturing a three-dimensional shaped object is provided with an ultraviolet ray irradiating part. The binder solution preferably includes an ultraviolet curable resin.

This makes it possible to impart particularly excellent mechanical strength to the three-dimensional shaped object being manufactured.

In the apparatus for manufacturing a three-dimensional shaped object, preferably, the side surface support part is configured and arranged to absorb ultraviolet rays.

This makes it possible to reduce failures of the binder solution applying part and even more effectively prevent the occurrence of defects in the three-dimensional shaped object, and makes it possible to impart even more excellent dimensional accuracy to the three-dimensional shaped object being manufactured.

A method of manufacturing a three-dimensional shaped object according to another aspect includes manufacturing the three-dimensional shaped object using the apparatus for manufacturing a three-dimensional shaped object as set forth the above aspects.

This makes it possible to provide a method of manufacturing a three-dimensional shaped object enabling the efficient manufacture of a three-dimensional shaped object which has excellent dimensional accuracy and with which the occurrence of defects has been effectively prevented.

A method of manufacturing a three-dimensional shaped object according to another aspect is adapted to carry out a layer forming step a plurality of times to form layers using a composition in paste form including particles to form a three-dimensional shaped object. The method of manufacturing a three-dimensional shaped object includes: where any one of a plurality of the layers is a first layer, a step for forming the first layer is a first layer formation step, a layer that is formed directly atop the first layer is a second layer, and a step for forming the second layer is a second layer formation step, between the first layer formation step and the second layer formation step, spacing a side surface support part for supporting side surfaces of the layers apart from the side surfaces of the layers; moving a stage where the layers are formed and the side surface support part in a relative manner in a direction of layering of the layers; and abutting the side surface support part against the side surfaces of the layers.

This makes it possible to provide a method of manufacturing a three-dimensional shaped object enabling the efficient manufacture of a three-dimensional shaped object which has excellent dimensional accuracy and with which the occurrence of defects has been effectively prevented.

The method of manufacturing a three-dimensional shaped object preferably further includes applying a binder solution for binding the particles onto the layers, between the first layer formation step and the spacing of the side surface support part.

This makes it possible to endow the three-dimensional shaped object with excellent mechanical strength.

A three-dimensional shaped object according to another aspect is manufactured using the apparatus for manufacturing a three-dimensional shaped object as set forth the above aspects.

This makes it possible to provide a three-dimensional shaped object which has excellent dimensional accuracy and with which the occurrence of defects has been effectively prevented.

### BRIEF DESCRIPTION OF THE DRAWINGS

Referring now to the attached drawings which form a part of this original disclosure:

FIGS. 1A to 1D are cross-sectional views schematically illustrating respective steps as regards a preferred embodiment of a method of manufacturing a three-dimensional shaped object of the present invention;

FIGS. 2A to 2D are cross-sectional views schematically illustrating respective steps as regards a preferred embodiment of a method of manufacturing a three-dimensional shaped object of the present invention;

FIGS. 3A to 3D are cross-sectional views schematically illustrating respective steps as regards a preferred embodiment of a method of manufacturing a three-dimensional shaped object of the present invention;

FIGS. 4A to 4C are cross-sectional views schematically illustrating respective steps as regards a preferred embodiment of a method of manufacturing a three-dimensional shaped object of the present invention;

FIG. 5 is a cross-sectional view schematically illustrating a preferred embodiment of an apparatus for manufacturing a three-dimensional shaped object of the present invention;

FIG. 6 is a plan view illustrating the shape of constituent members of a side surface support part provided to an apparatus for manufacturing a three-dimensional shaped object;

FIG. 7 is a plan view illustrating the shape of constituent members of a side surface support part provided to an apparatus for manufacturing a three-dimensional shaped object;

FIG. 8 is a cross-sectional view schematically illustrating another preferred embodiment of an apparatus for manufacturing a three-dimensional shaped object in the present invention;

FIG. 9 is a cross-sectional view schematically illustrating a state in a layer (three-dimensional shaping composition) immediately before a binder solution application step; and

FIG. 10 is a cross-sectional view schematically illustrating a state where particles have been bound together by a hydrophobic binding agent.

### DETAILED DESCRIPTION OF EXEMPLARY EMBODIMENTS

Preferred embodiments of the present invention shall now be described in greater detail below, with reference to the accompanying drawings.

### Method of Manufacturing Three-Dimensional Shaped Object

First, a method of manufacturing a three-dimensional shaped object in the present invention shall be described.

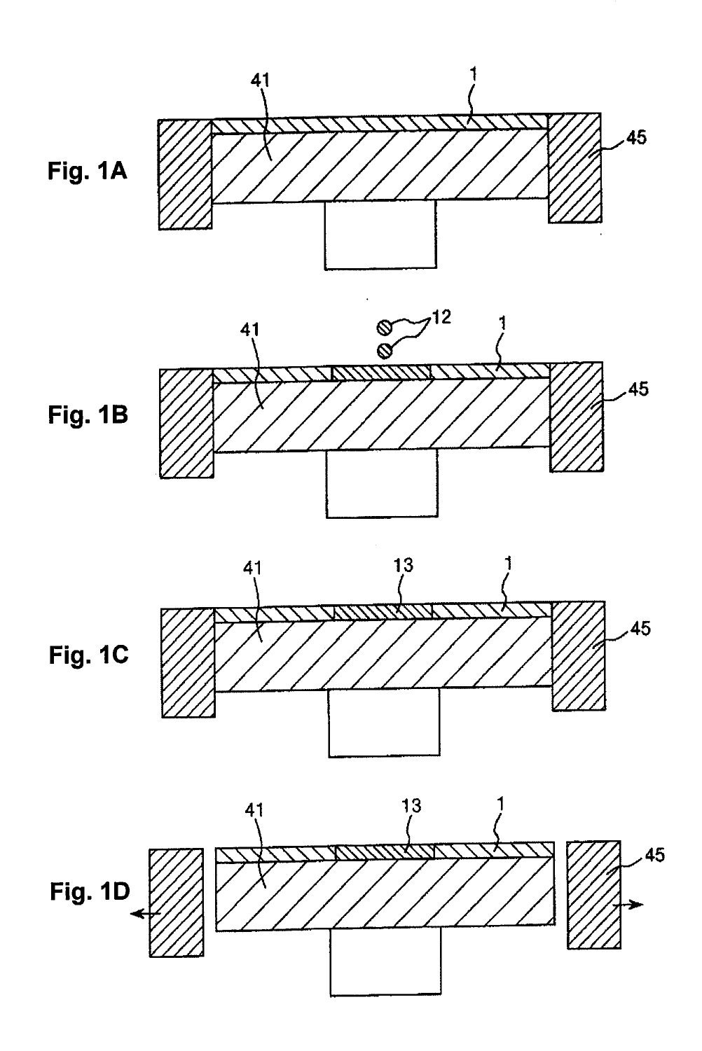

FIGS. 1A to 4C are cross-sectional views schematically illustrating respective steps as regards a preferred embodiment of a method of manufacturing a three-dimensional shaped object of the present invention.

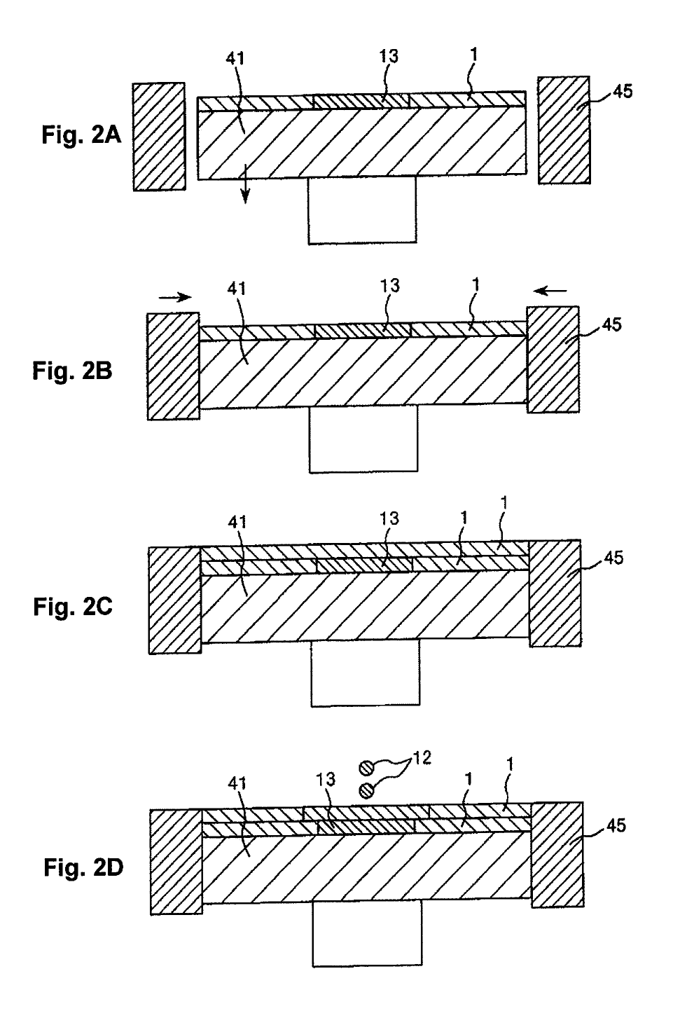

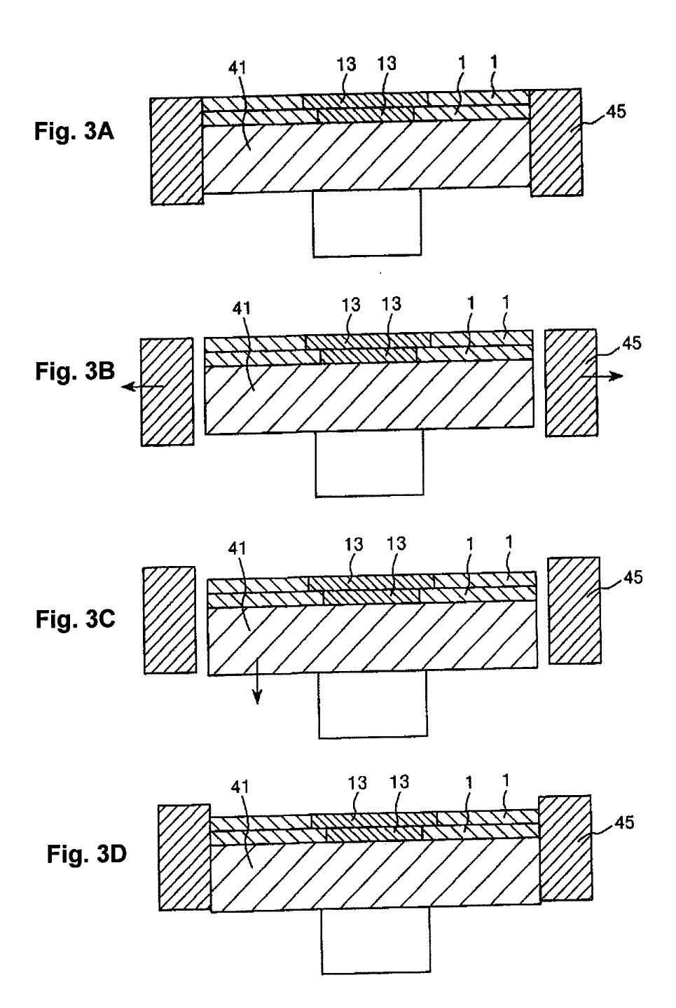

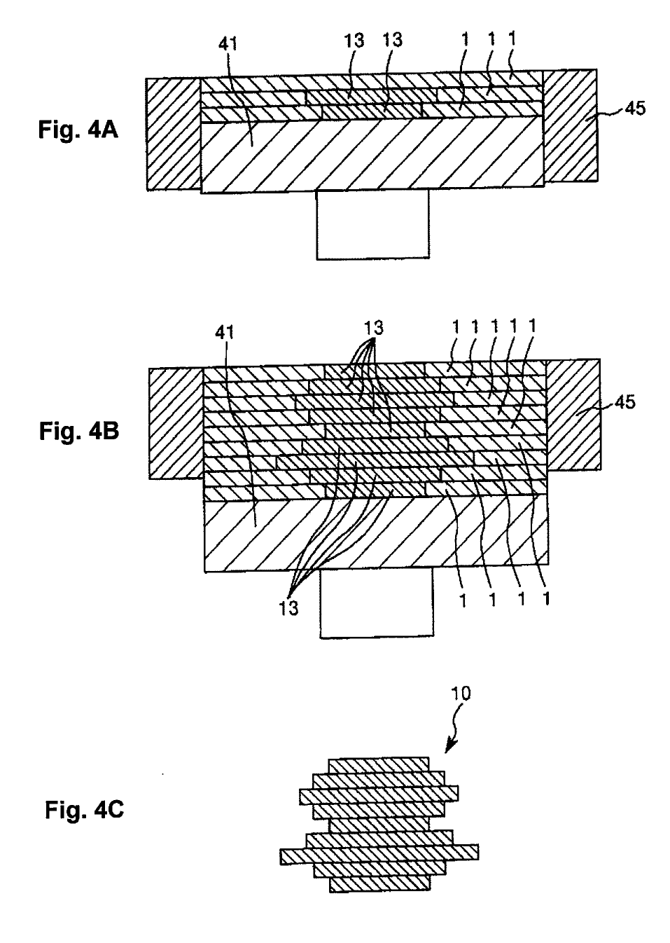

As illustrated in FIGS. 1A to 4C, a method of manufacture in the present embodiment comprises: a layer formation step (FIGS. 1A, 2C, 4A) in which a composition 11 in paste form that comprises particles 111 is used to form a layer 1 having a predetermined thickness; a binder solution application step (FIGS. 1B, 2D) in which a binder solution 12 is applied to the layer 1 by inkjet; and a curing step (binding step) (FIGS. 1C, 3A) in which a binding agent 121 included in the binder solution 12 having been applied to the layer 1 is cured and the particles 111 are bound, thereby forming a curing part (binding part) 13 in the layer 1; these steps being repeated sequentially and there being, after these steps, an unbound particle removal step (FIG. 4C) in which those particles 111 constituting each of the layers 1 that have not been bound by the binding agent 121 are removed.

Before the second and subsequent rounds of the layer formation step (steps in which a second layer, which is a new layer 1 that needs to be formed, is formed), a side surface support part spacing step (FIGS. 1D, 3B) in which a side surface support part 45 for supporting a side surface of a first layer, the first layer being the previously formed layer 1, is carried out; a layering direction movement step (FIGS. 2A, 3C) in which a stage 41 is lowered in a state where the side surface support part 45 has been spaced apart from the layer 1 is carried out, and thereafter, a side surface support part abutment step (FIGS. 2B, 3D) in which the side surface support part 45 is abutted against the layer 1 is carried out. That is to say, when the stage 41 is being lowered, the side surface support part 45 is spaced apart from the layer 1 (the first layer), and when the new layer 1 (the second layer) is being formed, the side surface support part 45 having once been spaced apart is again brought into contact with the layer 1 (the first layer).

In this manner, enforcing a state where the side surface support part 45 and the layer 1 have been spaced apart when the stage 41 is being moved makes it possible to reliably prevent sliding resistance from causing the layer 1 to experience unintended deformation (disturbance). As a result, the three-dimensional shaped object 10 that is ultimately obtained can be given excellent dimensional accuracy and effectively prevented from developing defects. It would also be conceivable to not use a region of the layer that experiences disturbance for the three-dimensional shaped object, and only use a region of the layer that does not experience disturbance, but in such a case, it is not possible to effectively utilize the stage (the utilized surface area ratio becomes lower), the productivity of the three-dimensional shaped object becomes lower, and a large-sized three-dimensional shaped object cannot be manufactured, among other problems; however, according to the present invention, such problems can be prevented from occurring, and a three-dimensional shaped object can be efficiently manufactured.

In the present invention, the terms “first layer” and “second layer” are meant to illustrate the relative relationship between two layers out of the plurality of layers that constitute the three-dimensional shaped object. More specifically, in the context of forming an n+1-th layer 1 on an n-th layer 1, the n-th layer 1 would be called the “first layer” and the n+1-th layer 1 would be called the “second layer”, whereas in the later context of forming an n+2-th layer 1 on the n+1-th layer 1, the n+1-th layer 1 would be called the “first layer” and the n+2-th layer 1 would be called the “second layer”.

Each of the steps shall now be described below.

### Layer Formation Step

In the layer formation step, the composition (three-dimensional shaping composition) 11 in paste form that comprises the particles 111 is used to form the layer 1 having a predetermined thickness (FIGS. 1A, 2C, 4A).

Using a composition in paste form as the composition 11 makes it possible to raise the fluidity of the composition 11 and improve the workability during formation of the layer 1. It is also possible to prevent unintended scattering or the like of the powder (particles 111) at such times as the formation of the layer 1.

In the present invention, being in paste form encompasses things that comprise a component that takes a liquid form in the layer formation step, and compositions in paste form would include, for example, those that comprise a solvent component, those that comprise a component which takes the form of a solid at room temperature but is melted by being heated in the layer formation step, and the like.

The composition 11 shall be described in greater detail below.

In the present step, a flattening part is used to form the layer 1 so as to have a flattened surface.

In the first round of the layer formation step, the layer 1 is formed at a predetermined thickness on a surface of the stage 41 (FIG. 1A). At this time, a side surface of the stage 41 and the side surface support part 45 are in a closely contacted (abutted) state, and the composition 11 is prevented from descending from between the stage 41 and the side surface support part 45.

In the second and subsequent rounds of the layer formation step, the new layer 1 (the second layer) is formed on the surface of the layer 1 formed in the previous step (the first layer) (FIGS. 2C, 4A). At this time, the side surface of the layer 1 (referring at least to the layer 1 that is provided uppermost in a case where there are a plurality of layers 1 on the stage 41) of the stage 41 and the side surface support part 45 are in a closely contacted (abutted) state, and the composition 11 is prevented from descending from between the stage 41 and the layer 1 on the stage 41.

In the present step, the composition 11 may be heated. This makes it possible to cause the composition to be more suitably in paste form in a case where, for example, the composition comprises a molten component.

The viscosity (a value measured using an E-type viscometer (the VISCONIC ELD made by Tokyo Keiko) of the composition 11 in the present step is preferably 7,000 to 60,000 mPa·s, more preferably 10,000 to 50,000 mPa·s. This makes it possible to more effectively prevent the occurrence of an unintended variance in the thickness in the layer 1 being formed.

Though not particularly limited, the thickness of the layer 1 being formed in the present step is, for example, preferably 30 to 500 μm, more preferably 70 to 150 μm. This makes it possible to more effectively prevent, inter alia, the occurrence of unintended irregularities in the three-dimensional shaped object 10 that is manufactured, while also giving the three-dimensional shaped object 10 ample and excellent productivity, and makes it possible to give the three-dimensional shaped object 10 particularly excellent dimensional accuracy.

### Binder Solution Application Step

After the layer 1 has been formed in the layer formation step, the binder solution 12 for binding the particles 111 constituting the layer 1 is applied to this layer 1 by inkjet (FIGS. 1B, 2D).

In the present step, the binder solution 12 is selectively applied to only a site of the layer 1 that corresponds to a substantive section (a site where there is substance) of the three-dimensional shaped object 10.

This makes it possible to firmly bind together the particles 111 constituting the layer 1, and ultimately to form a curing part (binding part) 13 of a desired shape. The three-dimensional shaped object 10 that is ultimately obtained can also be given excellent mechanical strength.

In the present step, the binder solution 12 is applied by inkjet, and therefore the binder solution 12 can be applied with favorable reproducibility even when a pattern of application of the binder solution 12 is finely shaped. As a result, the three-dimensional shaped object 10 that is ultimately obtained can be given particularly high dimensional accuracy.

The binder solution 12 shall be described in greater detail below.

### Curing Step (Binding Step)

After the binder solution 12 has been applied to the layer 1 in the binder solution application step, the binding agent 121 that is included in the binder solution 12 having been applied to the layer 1 is cured, to form the curing part (binding part) 13 (FIGS. 1C, 3A). This makes it possible to impart especially excellent binding strength between the binding agent 121 and the particles 111, and consequently makes it possible for the three-dimensional shaped object 10 that is ultimately obtained to have especially excellent mechanical strength.

The present step varies depending on the type of the binding agent 121, but examples could include being performed by heating in a case where the binding agent 121 is a thermo-curable resin, or being performed by irradiating with a corresponding light in a case where the binding agent 121 is a photo-curable resin (for example, by irradiating with ultraviolet rays in a case where the binding agent 121 is an ultraviolet-curable resin).

The binder solution application step and the curing step may be performed at the same time. That is to say, before the entire pattern of an entire one layer 1 is formed, the curing reaction may be allowed to proceed sequentially from the site where the binder solution 12 has been applied.

The present step could also be omitted in a case where, for example, the binding agent 121 is not a curable component. In such a case, the binder solution application step described above would also serve as a binding step.

### Side Surface Support part Spacing Step

The side surface support part 45 is spaced apart from a side surface of the layer 1 where the curing part (binding part) 13 has been formed (FIGS. 1D, 3B).

This manner of having spaced the side surface support part 45 apart from the side surface of the layer 1 in advance before the descent of the stage 41 in a later step makes it possible to reliably prevent sliding resistance from causing the layer 1 to experience an unintended disturbance.

### Layering Direction Movement Step

In the layering direction movement step, the stage 41 is lowered in a state where the side surface support part 45 has been spaced apart from the side surface of the layer 1 where the curing part (binding part) 13 has been formed (FIGS. 2A, 3C).

This causes the upper surface of the side surface support part 45 and the layer 1 (the first layer) that is on the stage 41 to have a stepped difference in height corresponding to the thickness of the new layer 1 that needs to be formed (the second layer). This makes it possible to form a layer 1 (the second layer) of a desired thickness in the subsequent layer formation step.

Also, in the present step, a state is enacted where the layer 1 on the stage 41 and the side surface support part 45 are spaced apart from one another, and therefore the layer 1 on the stage is reliably prevented from experiencing unintended disturbance caused by sliding resistance.

### Side Surface Support part Abutment Step

After the stage 41 has been lowered by a predetermined amount, the side surface support part 45 is abutted against the layer 1 (referring at least to the layer 1 that is provided uppermost in a case where there are a plurality of layers 1 on the stage 41) on the stage (FIGS. 2B, 3D).

This manner of abutting the side surface support part 45 against the side surface of the layer 1 in the present step prevents the composition 11 from descending from between the layer 1 on the stage 41 and the side surface support part 45.

The side surface support part spacing step, the layering direction movement step, the side surface support part abutment step, and the like need not be performed after the layer formation step for forming the final layer 1.

### Unbound Particle Removal Step

Then, after the series of steps described above has been repeatedly carried out, the unbound particle removal step (FIG. 4C) is carried out as a post-treatment step, in which those particles 111 constituting each of the layers 1 that have not been bound by the binding agent 121 (unbound particles) are removed. The three-dimensional shaped object 10 is thereby retrieved.

Examples of a specific method for the present step could include a method of dispelling the unbound particles with a brush or the like, a method of removing the unbound particles by suction, a method of blowing a gas such as air, a method of applying a liquid such as water (for example, a method of immersing the laminate obtained in the manner described above into a liquid, a method of spraying a liquid, or the like), or a method of applying a vibration such as ultrasonic vibration. Two or more types of methods selected from these could also be performed in combination. More specific examples might be a method of blowing a gas such as air and thereafter immersing in a liquid such as water, or a method of applying an ultrasonic vibration in a state of having been immersed in a liquid such as water. It would be particularly preferable to use a method of applying a liquid that contains water to the laminate obtained in the manner described above (in particular, a method of immersing in a liquid that contains water).

The formation of the binding part has been described above as being carried out using the binder solution, but in the method of manufacture of the present invention, the formation of the binding part may be carried out by any method; for example, the formation of the binding part may be carried out by irradiating with energy rays to fuse (sinter, bond) the particles 11.

According to the method of manufacture of the present invention as described above, it is possible to efficiently manufacture a three-dimensional shaped object which has excellent dimensional accuracy and with which the occurrence of defects has been effectively prevented.

### Apparatus for Manufacturing Three-Dimensional Shaped Object

An apparatus for manufacturing a three-dimensional shaped object in the present invention shall be described next.

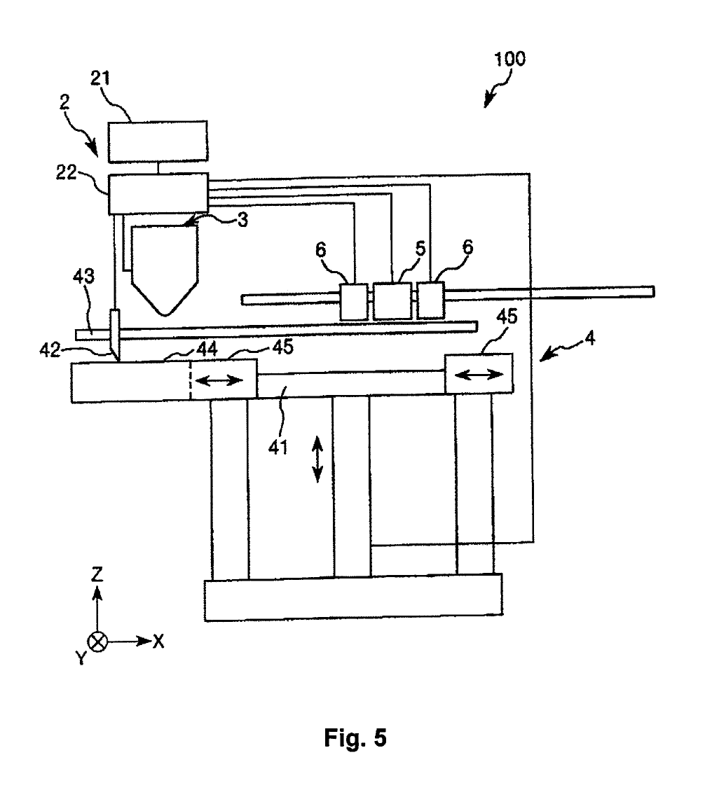

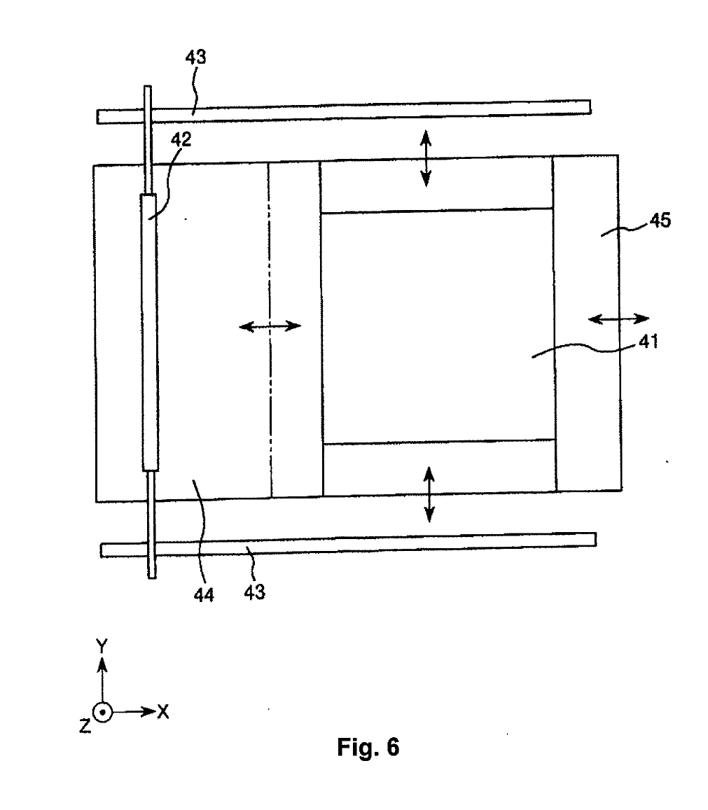

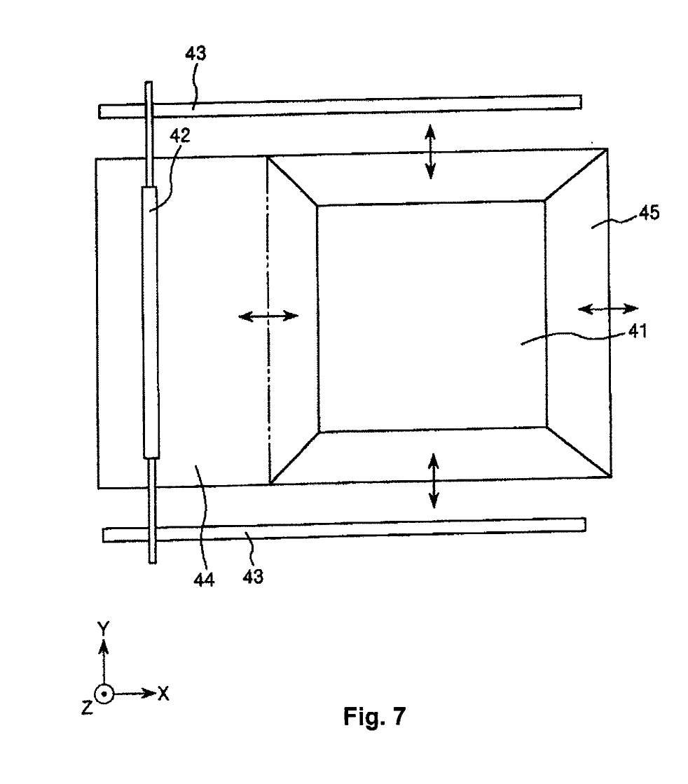

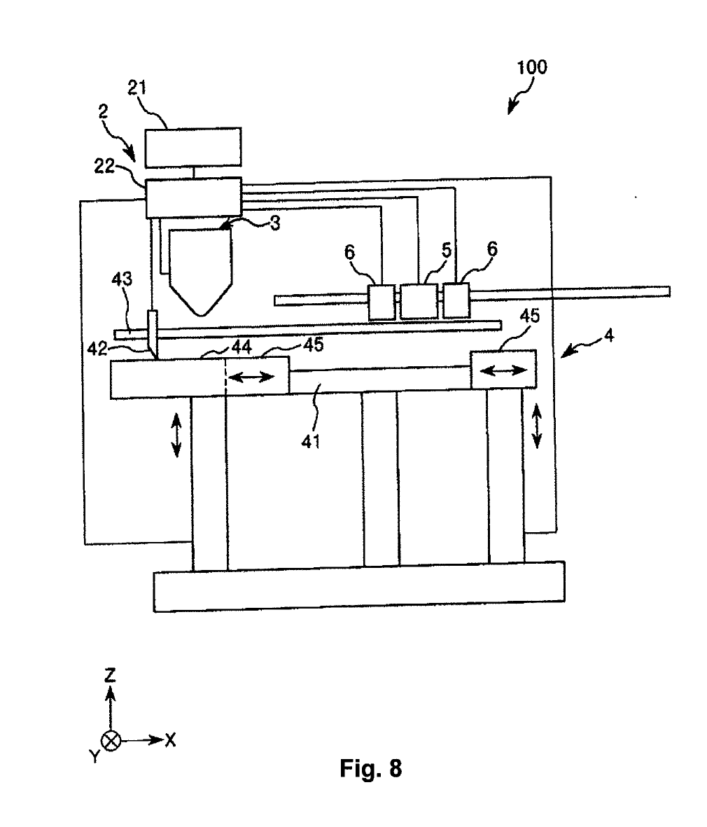

FIG. 5 is a cross-sectional view schematically illustrating a preferred embodiment of an apparatus for manufacturing a three-dimensional shaped object of the present invention; FIG. 6 is a plan view illustrating the shape of a constituent member of a side surface support part provided to an apparatus for manufacturing a three-dimensional shaped object; FIG. 7 is a plan view illustrating the shape of a constituent member of a side surface support part provided to an apparatus for manufacturing a three-dimensional shaped object; and FIG. 8 is a cross-sectional view schematically illustrating another preferred embodiment of an apparatus for manufacturing a three-dimensional shaped object in the present invention.

An apparatus 100 for manufacturing a three-dimensional shaped object is one that manufactures the three-dimensional shaped object 10 by using the composition (three-dimensional shaping composition) 11 in paste form that comprises the particles 111 to repeatedly fashion and successively lay down the layers 1.

As illustrated in FIG. 5, the apparatus 100 for manufacturing a three-dimensional shaped object has: a control unit 2; a composition supply part 3 for storing the composition 11 in paste form that comprises the particles 111; a layer formation part 4 for forming the layer 1 by using the composition 11 that has been supplied from the composition supply part 3; a binder solution discharge section (binder solution applying part) 5 for discharging the binder solution 12 onto the layer 1; and an energy ray irradiating part (curing part) 6 for irradiating with energy rays for curing the binder solution 12 (the same is also true of the apparatus 100 for manufacturing a three-dimensional shaped object that illustrated in FIG. 8).

The control unit 2 has a computer 21 and a drive control unit 22.

The computer 21 is, inter alia, a common desktop computer configured to be provided with a CPU, memory, and the like inside. The computer 21 outputs, to the drive control unit, cross-sectional data (slice data) obtained by running data conversion to make the shape of the three-dimensional shaped object 10 into model data and slicing same into many parallel layers of thin cross-sections.

The drive control unit 22 functions as a control part for respectively driving the layer formation part 4, the binder solution discharge section 5, the energy ray irradiating part 6, and the like. A more specific example of what is controlled is the discharged pattern and discharged amount of the binder solution 12 from the binder solution discharge section 5, the supplied amount of the composition 11 from the composition supply part 3, the amount by which the stage 41 is lowered, and the like.

The composition supply part 3 is moved by a command from the drive control unit 22 and is configured so that the composition 11 that is stored in the interior is supplied to a composition temporary placement part 44.

The layer formation part 4 has: the composition temporary placement part 44, which temporarily holds the composition 11 having been supplied from the composition supply part 3; a squeegee (flattening part) 42 for forming the layer 1 while also flattening the composition 11 having been held by the composition temporary placement part 44; guide rails 43 for regulating the operation of the squeegee 42; the stage 41, which supports the layer 1 that has been formed; and the side surface support part 45, which surrounds the stage 41.

The stage 41 is lowered successively by a predetermined amount by a command from the drive control unit 22 when a new layer 1 is to be formed on a previously formed layer 1. The amount by which the stage 41 is lowered defines the thickness of the new layer 1 being formed.

Also, as illustrated in FIG. 5, the stage 41 is configured so as to be movable in the Z direction (up-down direction), which makes it possible to reduce the number of members that need to move in order to adjust the thickness of the layer 1 when the new layer 1 is to be formed, and therefore makes it possible to make a simpler configuration for the apparatus 100 for manufacturing a three-dimensional shaped object.

The stage 41 is one that has a flat surface (the site to which the composition 11 is applied). This makes it possible to easily and reliably form layers 1 that have a highly uniform thickness.

The stage 41 is preferably constituted of a high-strength material. Examples of the constituent material of the stage 41 include a variety of metal materials such as stainless steel.

The surface (site where the composition 11 is applied) of the stage 41 may also be subjected to a surface treatment. This makes it possible, for example, to more effectively prevent the constituent material of the composition 11 or the constituent material of the binder solution 12 from ending up sticking to the stage 41, or give the stage 41 particularly excellent durability and achieve stable production of the three-dimensional shaped object 10 over a longer period. Examples of the material used for the surface treatment of the surface of the stage 41 could include a fluorine resin such as polytetrafluoroethylene, or the like.

The squeegee 42 is one that has a longitudinal shape that extends in the Y direction, and is provided with a blade that has a cutting edge shape with a pointed lower tip.

The Y-direction length of the blade is not less than the width (Y-direction length) of the stage 41 (shaping region).

The apparatus 101 for manufacturing a three-dimensional shaped object may also be provided with a vibration mechanism (not shown) for applying a minute vibration to the blade so that the diffusion of the composition 11 by the squeegee 42 can provided smoothly.

The side surface support part 45 has the function of supporting the side surface of the layer 1 formed on the stage 41. The side surface support part 45 also has the function of regulating the surface area of the layer 1 during the formation of the layer 1.

The side surface support part (frame) 45 is configured so as to be spaced apart from the side surface of the layer 1 provided on the stage 41 when the stage 41 moves in the Z-direction (up-down direction). This makes it possible to reliably prevent sliding resistance from causing the layer 1 on the stage 41 to experience unintended deformation (disturbance) when the stage 41 is being lowered.

A portion of the side surface support part 45 that is arranged at least on both sides in a first direction, which is a relative movement direction of the squeegee (flattening part) 42 (referring, for example, to members provided to the left side and right side of the side surface support part 45 as depicted in the configuration illustrated in FIGS. 6 and 7), is preferably configured so as to be spaced apart from the side surface of the layer 1.

The portion of the side surface support part 45 that is arranged on both sides of the first direction is a portion of the side surface support part 45 against which the composition 11 is pressed particularly strongly by the action of the squeegee 42, and the problems as described above take place more prominently in a case where the stage 41 is lowered in a state where the side surface support part 45 and the layer 1 are in contact. As such, the effects of the present invention are more prominently exhibited by configuring so that at least the portion of the side surface support part 45 that is arranged on both sides in the first direction, which is the relative movement direction of the squeegee (flattening part) 42, is spaced apart from the side surface of the layer 1.

Also, a portion of the side surface support part 45 that is arranged at least on both sides in a second direction orthogonal to the first direction (but in the in-plane direction of the layer 1) (referring, for example, to members provided to the upper side and lower side of the side surface support part 45 as depicted in the configuration illustrated in FIGS. 6 and 7), is preferably also configured so as to be spaced apart from the side surface of the layer 1.

This makes it possible to even more effectively prevent the occurrence of defects in the three-dimensional shaped object 10 being manufactured, and possible to give the three-dimensional shaped object 10 being manufactured even more excellent dimensional accuracy.

In particular, in the configuration illustrated in FIGS. 6 and 7, the side surface support part 45 is constituted of four members that correspond to the four sides (each of the sides of a rectangle) of the stage 41. Each of the members constituting the side surface support part 45 is configured so as to be able to move in the direction of approaching or separating from the layer while the surface abutting against the layer 1 also maintains a parallel state with respect to the corresponding respective side of the stage 41.

In the configuration illustrated in FIGS. 6 and 7, the members constituting the side surface support part 45 each form surfaces in close contact with one another in the state where the side surface support part 45 abuts against the layer 1 on the stage 41. This makes it possible to impart particularly excellent stability of shape for the side surface support part 45 during the formation of the layer 1, makes it possible to more reliably prevent the occurrence of an unintended gap between the members in instances such as where an external force from the squeegee 42 is applied, and makes it possible to impart particularly excellent stability of shape for the shape 1 being formed. As a result, the three-dimensional shaped object 10 that is ultimately obtained can be endowed with particularly excellent dimensional accuracy and reliability.

In the configuration illustrated in FIGS. 6 and 7, one of the members constituting the side surface support part 45 is formed integrally with the composition temporary placement part 44, but the members constituting the side surface support part 45 and the composition temporary placement part 44 may also be provided as separate bodies from one another.

The apparatus 100 for manufacturing a three-dimensional shaped object is preferably provided with a heating part (not shown) for heating the side surface support part 45.

This makes it possible to effectively prevent the layer 1 from sticking to the side surface support part 45, and makes it possible to more reliably prevent the layer 1 from experiencing unintended deformation (disturbance).

In a case where the apparatus 100 for manufacturing a three-dimensional shaped object is indeed provided with a heating part for heating the side surface support part 45, then the position of installation of the heating part is not particularly limited but may be, for example, the interior of the side surface support part 45, or may be the exterior of the side surface support part 45.

Preferably, the side surface support part 45 absorbs ultraviolet ray.

This reduces faulty application caused by when ultraviolet rays reflected at the side surface support part 45 hit the binder solution applying part 5 and the binder solution 12 cures.

The binder solution applying part (binder solution discharge section) 5 is for applying the binder solution 12 to the layer 1.

Being provided with the binder solution applying part 5 of such description makes it possible to easily and reliably give the three-dimensional shaped object 10 excellent mechanical strength.

In particular, in the present embodiment, the binder solution applying part 5 is a binder solution discharge section for discharging the binder solution 12 by inkjet.

This makes it possible to apply the binder solution 12 in a finely detailed pattern, and makes it possible for even a three-dimensional shaped object 10 having a finely detailed structure to be manufactured with particularly favorable productivity.

A piezoelectric format, a format where the binder solution 12 is heated and the bubbles generated cause the binder solution 12 to be discharged, or the like can be used as the liquid droplet discharge format (format of inkjet), but the piezoelectric format is preferably in terms of the difficulty of alteration of the constituent components of the binder solution 12 and the like.

In the binder solution discharge section (binder solution applying part) 5, a command from the drive control unit 22 controls the pattern that needs to be formed in each of the layers, as well as the amount of the binder solution 12 that is applied in each part of the layer 1. The discharged pattern, discharged amount, and the like of the binder solution 12 discharged by the binder solution discharge section (binder solution applying part) 5 are determined on the basis of the slice data.

The energy ray irradiating part (curing part) 6 is for irradiating with energy rays for curing the binder solution 12 having been applied to the layer 1.

The type of energy rays with which the energy ray irradiating part 6 irradiates will vary depending on the constituent material of the binder solution 12, but examples include ultraviolet rays, visible light rays, infrared rays, X-rays, gamma rays, electron beams, ion beams, and the like. In particular, it would be preferable to use ultraviolet rays in terms of costs and the productivity of the three-dimensional shaped object.

In the configuration illustrated in FIG. 5, the stage 41 is able to move in the Z-direction (up-down direction), whereas in the configuration illustrated in FIG. 8, the side surface support part 45 is configured so as to be able to move in the Z-direction (up-down direction). In this manner, in the present invention, it suffices for the stage and the side surface support part to be able to move in a relative fashion in the up-down direction.

In particular, configuring so that the side surface support part 45 is able to move in the Z-direction (up-down direction), as illustrated in FIG. 8, makes it possible to suitable manufacture the three-dimensional shaped object 10 even in a case where, for example, the stage 41 has a large surface area, or a case where the three-dimensional shaped object 10 that needs to be manufactured weighs a large amount. Vibration of the stage 41 and the like is also more effectively prevented, and therefore so doing is also advantageous in terms of further improving the dimensional accuracy of the three-dimensional shaped object 10.

In a case where the side surface support part 45 is able to move in the Z-direction (up-down direction), as illustrated in FIG. 8, the side surface support part 45 is raised by a predetermined amount by a command from the drive control unit 22 when the new layer 1 is being formed on the previously formed layer 1. The amount by which the side surface support part 45 is raised defines the thickness of the new layer 1 being formed.

The preceding description posits that the apparatus for manufacturing a three-dimensional shaped object is one that has a binder solution discharge section (binder solution applying part) and an energy ray irradiating part (curing part), and thereby forms the curing part (binding part), but the apparatus for manufacturing a three-dimensional shaped object in the present invention is not limited to being one provided with such a configuration as the means for forming the binding part, and in one example may be provided with an energy ray irradiating part for irradiating with energy rays for fusing (sintering, bonding) the particles instead of the binder solution discharge section (binder solution applying part) and the energy ray irradiating part (curing part).

In a case where the apparatus for manufacturing a three-dimensional shaped object is one that is provided with an energy ray irradiating part for irradiating with energy rays for fusing (sintering, bonding) the particles, then in this energy ray irradiating part, the command from the drive control unit 22 controls the pattern (pattern of irradiation of energy rays) that needs to be formed in each of the layers 1, as well as the amount of energy of the energy rays with which each part of the layers 1 is irradiated. The pattern of irradiation, amount of energy, and the like for the energy rays from the energy ray irradiating part are determined on the basis of the slice data.

According to the apparatus for manufacturing a three-dimensional shaped object in the present invention as described above, it is possible to efficiently manufacture a three-dimensional shaped object which has excellent dimensional accuracy and with which the occurrence of defects has been effectively prevented.

### Composition (Three-Dimensional Shaping Composition)

The composition (three-dimensional shaping composition) 11 used in the manufacture of the three-dimensional shaped object in the present invention shall next be described in greater detail.

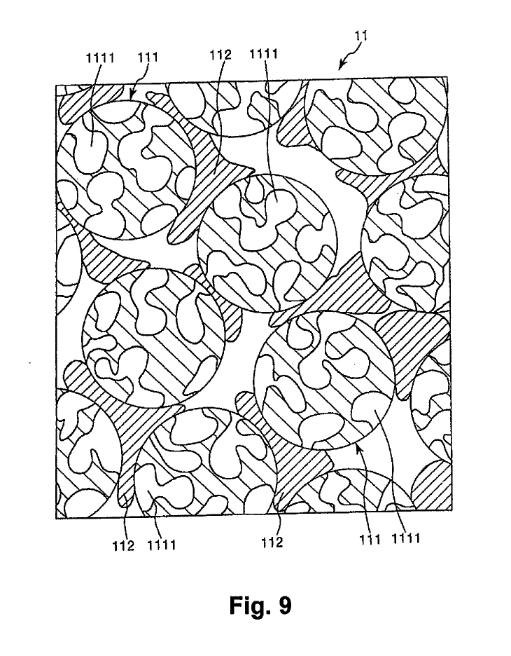

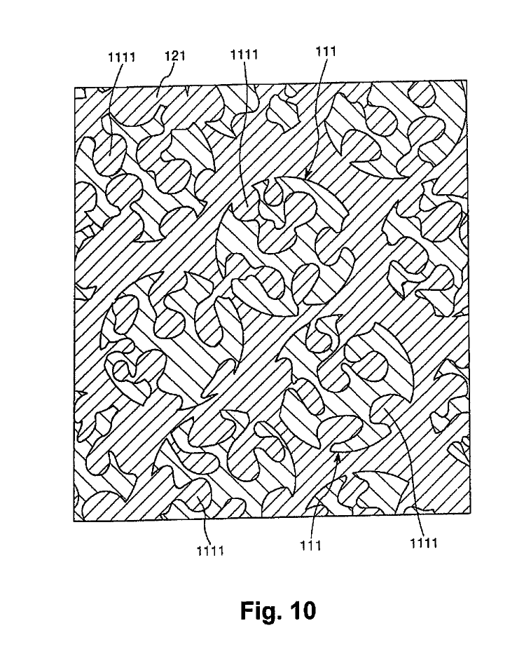

FIG. 9 is a cross-sectional view schematically illustrating a state in a layer (three-dimensional shaping composition) immediately before a binder solution application step; and FIG. 10 is a cross-sectional view schematically illustrating a state where particles have been bound together by a hydrophobic binding agent.

The composition (three-dimensional shaping composition) 11 is one that comprises at least a three-dimensional shaping powder comprising the plurality of particles 11, and takes the form of a paste.

### Three-Dimensional Shaping Powder (Particles 111)

Preferably, the particles 111 constituting the three-dimensional shaping powder are porous and have undergone a hydrophobic treatment. Having such a configuration makes it possible, in a case where the binder solution 12 is one that comprises a hydrophobic binding agent 121, to cause the hydrophobic binding agent 121 to suitably penetrate into holes 1111 when the three-dimensional shaped object 10 is being manufactured, thus causing an anchoring effect to be exerted and consequently making it possible to impart excellent binding strength (binding strength through the binding agent 121) in the binding between the particles 111, and, as a result, making it possible to suitably manufacture a three-dimensional shaped object 10 that has excellent mechanical strength (see FIG. 10). The three-dimensional shaping powder of such description can also be suitable reused. In a more detailed description, when the particles constituting the three-dimensional shaping powder have undergone a hydrophobic treatment, then a water-soluble resin 112 described below is prevented from entering into the holes 1111, and therefore washing with water or the like makes it possible for particles 111 of a region to which the binder solution 12 has not been applied to be recovered at high purity, with a low impurity content. For this reason, again mixing the recovered three-dimensional shaping powder with the water-soluble resin 112 and the like at a predetermined proportion makes it possible to reliably obtain a three-dimensional shaping composition that has been controlled to a desired composition. Also, the entry of the binding agent 121 constituting the binder solution 12 into the holes 1111 of the particles 111 makes it possible to effectively prevent unintended wetting and spreading of the binder solution 12. As a result, the three-dimensional shaped object 10 that is ultimately obtained can be given even higher dimensional accuracy.

Examples of the constituent material of the particles (mother particles undergoing hydrophobic treatment) constituting the three-dimensional shaping powder include inorganic materials, organic materials, and composites thereof.

Examples of an inorganic material constituting the particles 111 include a variety of metals or metal compounds. Examples of metal compounds could include: a variety of metal oxides such as silica, alumina, titanium oxide, zinc oxide, zirconium oxide, tin oxide, magnesium oxide, and potassium titanate; a variety of metal hydroxides such as magnesium hydroxide, aluminum hydroxide, and calcium hydroxide; a variety of metal nitrides such as silicon nitride, titanium nitride, and aluminum nitride; a variety of metal carbides such as silicon carbide and titanium carbide; a variety of metal sulfides such as zinc sulfide; carbonates of a variety of metals such as calcium carbonate and magnesium carbonate; sulfates of a variety of metals such as calcium sulfate and magnesium sulfate; silicates of a variety of metals such as calcium silicate and magnesium silicate; phosphates of a variety of metals such as calcium phosphate; borates of a variety of metals such as aluminum borate and magnesium borate; and composites thereof.

Examples of organic materials constituting the particles 111 could include synthetic resins and natural polymers, more specific examples being polyethylene resin; polypropylene; polyethylene oxide; polypropylene oxide, polyethylenimine; polystyrene; polyurethane; polyurea; polyester; silicone resin; acrylic silicone resin; polymers for which the constituent monomers are a (meth)acrylic acid ester such as poly(methyl methacrylate); crosspolymers for which the constituent monomers are a (meth)acrylic acid ester such as methyl methacrylate crosspolymer (ethylene acrylic acid copolymer resin or the like); polyamide resins such as nylon 12, nylon 6, or crosspolymer nylon; polyimide; carboxymethyl cellulose; gelatin; starch; chitin; and chitosan.

Of these, the particles 111 are preferably constituted of an inorganic material, more preferably constituted of a metal oxide, and even more preferably constituted of silica. This makes it possible to give the three-dimensional shaped object 10 particularly excellent properties such as mechanical strength and light resistance. The effects described above also become more prominent in particular when the particles 111 are constituted of silica. Additionally, silica possesses excellent fluidity as well, and therefore is advantageous in forming layers 1 of more highly uniform thickness and also makes it possible to give the three-dimensional shaped object 10 particularly excellent productivity and dimensional accuracy.

The particles 111 constituting the three-dimensional shaping powder may undergo any hydrophobic treatment provided that the hydrophobic treatment raises the hydrophobicity of the particles 111 (mother particles), but a preferable one is to introduce a hydrocarbon group. This makes it possible to give the particles 111 an even higher hydrophobicity. This also makes it possible to easily and reliably impart a higher uniformity in the extent of hydrophobic treatment in each of the particles 111 or at each site of the particle 111 surfaces (including the surfaces of the hole 1111 interiors).

A silane compound comprising a silyl group is preferable as the compound used for the hydrophobic treatment. Specific examples of compounds that can be used for the hydrophobic treatment include hexamethyldisilazane, dimethyldimethoxysilane, diethyldiethoxysilane, 1-propenylmethyldichlorosilane, propyldimethylchlorosilane, propylmethyldichlorosilane, propyltrichlorosilane, propyltriethoxysilane, propyltrimethoxysilane, styrylethyltrimethoxysilane, tetradecyltrichlorosilane, 3-thiocyanate propyltriethoxysilane, p-tolyldimethylchlorosilane, p-tolylmethyldichlorosilane, p-tolyltrichlorosilane, p-tolyltrimethoxysilane, p-tolyltriethoxysilane, di-n-propyldi-n-propoxysilane, diisopropyldiisopropoxysilane, di-n-butyldi-n-butyloxysilane, di-sec-butyldi-sec-butyloxysilane, di-t-butyldi-t-butyloxysilane, octadecyltrichlorosilane, octadecylmethyldiethoxysilane, octadecyltriethoxysilane, octadecyltrimethoxysilane, octadecyldimethylchlorosilane, octadecylmethyldichlorosilane, octadecylmethoxydichlorosilane, 7-octenyldimethylchlorosilane, 7-octenyltrichlorosilane, 7-octenyltrimethoxysilane, octylmethyldichlorosilane, octyldimethylchlorosilane, octyltrichlorosilane, 10-undecenyldimethylchlorosilane, undecyltrichlorosilane, vinyldimethylchlorosilane, methyloctadecyldimethoxysilane, methyldodecyldiethoxysilane, methyloctadecyldimethoxysilane, methyloctadecyldiethoxysilane, n-octylmethyldimethoxysilane, n-octylmethyldiethoxysilane, triacontyldimethylchlorosilane, triacontyltrichlorosilane, methyltrimethoxysilane, methyltriethoxysilane, methyl tri-n-propoxysilane, methylisopropoxysilane, methyl-n-butyloxysilane, methyl tri-sec-butyloxysilane, methyl tri-t-butyloxysilane, ethyltrimethoxysilane, ethyltriethoxysilane, ethyl tri-n-propoxysilane, ethylisopropoxysilane, ethyl-n-butyloxysilane, ethyl tri-sec-butyloxysilane, ethyl tri-t-butyloxysilane, n-propyltrimethoxysilane, isobutyltrimethoxysilane, n-hexyltrimethoxysilane, hexadecyltrimethoxysilane, n-octyltrimethoxysilane, n-dodecyltrimethoxysilane, n-octadecyltrimethoxysilane, n-propyltriethoxysilane, isobutyltriethoxysilane, n-hexyltriethoxysilane, hexadecyltriethoxysilane, n-octyltriethoxysilane, n-dodecyltrimethoxysilane, n-octadecyltriethoxysilane, 2-{2-(trichlorosilyl)ethyl}pyridine, 4-{2-(trichlorosilyl)ethyl} pyridine, diphenyldimethoxysilane, diphenyldiethoxysilane, 1,3-(trichlorosilylmethyl)heptacosane, dibenzyldimethoxysilane, dibenzyldiethoxysilane, phenyltrimethoxysilane, phenylmethyldimethoxysilane, phenyldimethylmethoxysilane, phenyldimethoxysilane, phenyldiethoxysilane, phenylmethyldiethoxysilane, phenyldimethylethoxysilane, benzyltriethoxysilane, benzyltrimethoxysilane, benzylmethyldimethoxysilane, benzyldimethylmethoxysilane, benzyldimethoxysilane, benzyldiethoxysilane, benzylmethyldiethoxysilane, benzyldimethylethoxysilane, benzyltriethoxysilane, dibenzyldimethoxysilane, dibenzyldiethoxysilane, 3-acetoxypropyltrimethoxysilane, 3-acryloxypropyltrimethoxysilane, allyltrimethoxysilane, allyltriethoxysilane, 4-aminobutyltriethoxysilane, (aminoethylaminomethyl)phenethyltrimethoxysilane, N-(2-aminoethyl)-3-aminopropylmethyldimethoxysilane, N-(2-aminoethyl)-3-aminopropyltrimethoxysilane, 6-(aminohexylaminopropyl)trimethoxysilane, p-aminophenyltrimethoxysilane, p-aminophenylethoxysilane, m-aminophenyltrimethoxysilane, m-aminophenylethoxysilane, 3-aminopropyltrimethoxysilane, 3-aminopropyltriethoxysilane, ω-aminoundecyltrimethoxysilane, amyltriethoxysilane, benzooxasilepin dimethyl ester, 5-(bicycloheptenyl)triethoxysilane, bis(2-hydroxyethyl)-3-aminopropyltriethoxysilane, 8-bromooctyltrimethoxysilane, bromophenyltrimethoxysilane, 3-bromopropyltrimethoxysilane, n-butyltrimethoxysilane, 2-chloromethyltriethoxysilane, chloromethylmethyldiethoxysilane, chloromethylmethyldiisopropoxysilane, p-(chloromethyl)phenyltrimethoxysilane, chloromethyltriethoxysilane, chlorophenyltriethoxysilane, 3-chloropropylmethyldimethoxysilane, 3-chloropropyltriethoxysilane, 3-chloropropyltrimethoxysilane, 2-(4-chlorosulfonylphenyl)ethyltrimethoxysilane, 2-cyanoethyltriethoxysilane, 2-cyanoethyltrimethoxysilane, cyanomethylphenethyltriethoxysilane, 3-cyanopropyltriethoxysilane, 2-(3-cyclohexenyl)ethyltrimethoxysilane, 2-(3-cyclohexenyl)ethyltriethoxysilane, 3-cyclohexenyltrichlorosilane, 2-(3-cyclohexenyl)ethyltrichlorosilane, 2-(3-cyclohexenyl)ethyldimethylchlorosilane, 2-(3-cyclohexenyl)ethylmethyldichlorosilane, cyclohexyldimethylchlorosilane, cyclohexylethyldimethoxysilane, cyclohexylmethyldichlorosilane, cyclohexylmethyldimethoxysilane, (cyclohexylmethyl)trichlorosilane, cyclohexyltrichlorosilane, cyclohexyltrimethoxysilane, cyclooctyltrichlorosilane, (4-cyclooctenyl)trichlorosilane, cyclopentyltrichlorosilane, cyclopentyltrimethoxysilane, 1,1-diethoxy-1-silacyclopenta-3-ene, 3-(2,4-dinitrophenylamino)propyltriethoxysilane, (dimethylchlorosilyl)methyl-7,7-dimethylnorpinane, (cyclohexylaminomethyl)methyldiethoxysilane, (3-cyclopentadienylpropyl)triethoxysilane, N,N-diethyl-3-aminopropyl)trimethoxysilane, 2-(3,4-epoxycyclohexyl)ethyltrimethoxysilane, 2-(3,4-epoxycyclohexyl)ethyltriethoxysilane, (furfuryloxymethyl)triethoxysilane, 2-hydroxy-4-(3-triethoxypropoxy)diphenyl ketone, 3-(p-methoxyphenyl)propylmethyldichlorosilane, 3-(p-methoxyphenyl)propyltrichlorosilane, p-(methylphenethyl)methyldichlorosilane, p-(methylphenethyl)trichlorosilane, p-(methylphenethyl)dimethylchlorosilane, 3-morpholinopropyltrimethoxysilane, (3-glycidoxypropyl)methyldiethoxysilane, 3-glycidoxypropyltrimethoxysilane, 1,2,3,4,7,7,-hexachloro-6-methyldiethoxysilyl-2-norbornene, 1,2,3,4,7,7,-hexachloro-6-triethoxysilyl-2-norbornene, 3-iodopropyltrimethoxysilane, 3-isocyanate propyltriethoxysilane, (mercaptomethyl)methyldiethoxysilane, 3-mercaptopropylmethyldimethoxysilane, 3-mercaptopropyldimethoxysilane, 3-mercaptopropyltriethoxysilane, 3-methacryloxypropylmethyldiethoxysilane, 3-methacryloxypropyltrimethoxysilane, methyl {2-(3-trimethoxysilylpropylamino)ethylamino}-3-propionate, 7-octenyltrimethoxysilane, R-N-α-phenethyl-N′-triethoxysilylpropylurea, S-N-α-phenethyl-N′-triethoxysilylpropylurea, phenethyltrimethoxysilane, phenethylmethyldimethoxysilane, phenethyldimethylmethoxysilane, phenethyldimethoxysilane, phenethyldiethoxysilane, phenethylmethyldiethoxysilane, phenethyldimethylethoxysilane, phenethyltriethoxysilane, (3-phenylpropyl)dimethylchlorosilane, (3-phenylpropyl)methyldichlorosilane, N-phenylaminopropyltrimethoxysilane, N-(triethoxysilylpropyl)dansylamide, N-(3-triethoxysilylpropyl)-4,5-dihydroimidazole, 2-(triethoxysilylethyl)-5-(chloroacetoxy)bicycloheptane, (S)-N-triethoxysilylpropyl-O-menthocarbamate, 3-(triethoxysilylpropyl)-p-nitrobenzamide, 3-(triethoxysilyl)propylsuccinic anhydride, N-{5-(trimethoxysilyl)-2-aza-1-oxo-pentyl} caprolactam, 2-(trimethoxysilylethyl)pyridine, N-(trimethoxysilylethyl)benzyl-N,N,N-trimethylammonium chloride, phenylvinyldiethoxysilane, 3-thiocyanate propyltriethoxysilane, (tridecafluoro-1,1,2,2,-tetrahydrooctyl)triethoxysilane, N-{3-(triethoxysilyl)propyl}phthalamate, (3,3,3-trifluoropropyl)methyldimethoxysilane, (3,3,3-trifluoropropyl)trimethoxysilane, 1-trimethoxysilyl-2-(chloromethyl)phenylethane, 2-(trimethoxysilyl)ethylphenylsulfonyl azide, β-trimethoxysilylethyl-2-pyridine, trimethoxysilylpropyldiethylenetriamine, N-(3-trimethoxysilylpropyl)pyrrole, N-trimethoxysilylpropyl-N,N,N-tributylammonium bromide, N-trimethoxysilylpropyl-N,N,N-tributylammonium chloride, N-trimethoxysilylpropyl-N,N,N-trimethylammonium chloride, vinylmethyldiethoxysilane, vinyltriethoxysilane, vinyltrimethoxysilane, vinylmethyldimethoxysilane, vinyldimethylmethoxysilane, vinyldimethylethoxysilane, vinylmethyldichlorosilane, vinylphenyldichlorosilane, vinylphenyldiethoxysilane, vinylphenyldimethylsilane, vinylphenylmethylchlorosilane, vinyltriphenoxysilane, vinyltris-t-butoxysilane, adamantylethyltrichlorosilane, allylphenyltrichlorosilane, (aminoethylaminomethyl)phenethyltrimethoxysilane, 3-aminophenoxydimethylvinylsilane, phenyltrichlorosilane, phenyldimethylchlorosilane, phenylmethyldichlorosilane, benzyltrichlorosilane, benzyldimethylchlorosilane, benzylmethyldichlorosilane, phenethyldiisopropylchlorosilane, phenethyltrichlorosilane, phenethyldimethylchlorosilane, phenethylmethyldichlorosilane, 5-(bicycloheptenyl)trichlorosilane, 5-(bicycloheptenyl)triethoxysilane, 2-(bicycloheptyl)dimethylchlorosilane, 2-(bicycloheptyl)trichlorosilane, 1,4-bis(trimethoxysilylethyl)benzene, bromophenyltrichlorosilane, 3-phenoxypropyldimethylchlorosilane, 3-phenoxypropyltrichlorosilane, t-butylphenylchlorosilane, t-butylphenylmethoxysilane, t-butylphenyldichlorosilane, p-(t-butyl)phenethyldimethylchlorosilane, p-(t-butyl)phenethyltrichlorosilane, 1,3-(chlorodimethylsilylmethyl)heptacosane, ((chloromethyl)phenylethyl)dimethylchlorosilane, ((chloromethyl)phenylethyl)methyldichlorosilane, ((chloromethyl)phenylethyl)trichlorosilane, ((chloromethyl)phenylethyl)trimethoxysilane, chlorophenyltrichlorosilane, 2-cyanoethyltrichlorosilane, 2-cyanoethylmethyldichlorosilane, 3-cyanopropylmethyldiethoxysilane, 3-cyanopropylmethyldichlorosilane, 3-cyanopropylmethyldichlorosilane, 3-cyanopropyldimethylethoxysilane, 3-cyanopropylmethyldichlorosilane, 3-cyanopropyltrichlorosilane, and fluorinated alkylsilanes; it would also be possible to use one species selected from these or a combination of two or more species selected from these.

Of these, it is preferable to use hexamethyldisilazane for the hydrophobic treatment. This makes it possible to give the particles 111 an even higher hydrophobicity. This also makes it possible to easily and reliably impart a higher uniformity in the extent of hydrophobic treatment in each of the particles 111 or at each site of the particle 111 surfaces (including the surfaces of the hole 1111 interiors).

In a case where a hydrophobic treatment in which a silane compound is used is conducted in a liquid phase, then immersing the particles 111 (mother particles) needing to undergo the hydrophobic treatment in a solution that contains the silane compound makes it possible to cause the desired reaction to proceed favorably and makes it possible to form a chemical adsorption film of the silane compound.

In a case where a hydrophobic treatment in which a silane compound is used is conducted in a gas phase, then exposing the particles 111 (mother particles) needing to undergo the hydrophobic treatment to a vapor of the silane compound makes it possible to cause the desired reaction to proceed favorably and makes it possible to form a chemical adsorption film of the silane compound.

Though not particularly limited, the mean particle size of the particles 111 constituting the three-dimensional shaping powder is preferably 1 to 25 μm, more preferably 1 to 15 μm. This makes it possible to give the three-dimensional shaped object 10 particularly excellent mechanical strength, and also makes it possible to more effectively prevent the occurrence of an undesirable unevenness in the three-dimensional shaped object 10 being manufactured or the like, and to give the three-dimensional shaped object 10 particularly excellent dimensional accuracy. This also makes it possible to impart particularly excellent fluidity to the three-dimensional shaping powder and particularly excellent fluidity to the composition (three-dimensional shaping composition) 11 that comprises the three-dimensional shaping powder, and possible to give the three-dimensional shaped object 10 particularly excellent productivity.

In the present invention, the “mean particle size” refers to the mean particle size based on volume, and can be found by, for example, adding methanol to a sample and dispersing same for three minutes with an ultrasonic disperser to obtain a dispersion solution and then measuring the dispersion solution with a Coulter counter particle size distribution measuring instrument (TA-II type made by Coulter Electronics Inc.) using a 50-μm aperture.

The Dmax (maximum diameter) of the particles 111 constituting the three-dimensional shaping powder is preferably 3 to 40 μm, more preferably 5 to 30 μm. This makes it possible to give the three-dimensional shaped object 10 particularly excellent mechanical strength, and also makes it possible to more effectively prevent the occurrence of an undesirable unevenness in the three-dimensional shaped object 10 being manufactured or the like, and to give the three-dimensional shaped object 10 particularly excellent dimensional accuracy. This also makes it possible to impart particularly excellent fluidity to the three-dimensional shaping powder and particularly excellent fluidity to the composition (three-dimensional shaping composition) 11 that comprises the three-dimensional shaping powder, and possible to give the three-dimensional shaped object 10 particularly excellent productivity.

The porosity of the particles 111 constituting the three-dimensional shaping powder is preferably 50% or higher, more preferably 55% to 90%. This makes it possible to cause there to be ample space (the holes 1111) for the binding agent to enter in and possible to give the particles 111 themselves excellent mechanical strength, and consequently makes it possible to impart particularly excellent mechanical strength to the three-dimensional shaped object 10 obtained when the binding agent 121 penetrates into the holes 1111. In the present invention, the “porosity” of the particles (particles) refers to the proportion (volume fraction) of holes present in the interior of the particles versus the apparent volume of the particles, and is a value represented by {(ρ₀−ρ)/ρ₀}×100, where ρ (g/cm³) is the density of the particles and ρ₀ (g/cm³) is the true density of the constituent material of the particles.

The mean hole size (pore diameter) of the particles 111 is preferably 10 nm or greater, more preferably 50 to 300 nm. This makes it possible to impart particularly excellent mechanical strength to the three-dimensional shaped object 10 that is ultimately obtained. In a case where a binder solution 12 (colored ink) comprising a pigment is used in the manufacture of the three-dimensional shaped object 10, then the pigment can be favorably retained inside the holes 1111 of the particles 111. For this reason, undesirable spreading of the pigment can be prevented, and a high-definition image can be more reliably formed.

The particles 111 constituting the three-dimensional shaping powder may have any shape, but preferably have a spherical shape. This makes it possible to give the three-dimensional shaping powder particularly excellent fluidity and give the composition (three-dimensional shaping composition) 11 comprising the three-dimensional shaping powder particularly excellent fluidity, and to give the three-dimensional shaped object 10 particularly excellent productivity, and also makes it possible to more effectively prevent the occurrence of an undesirable unevenness in the three-dimensional shaped object 10 being manufactured or the like, and to give the three-dimensional shaped object 10 particularly excellent dimensional accuracy.

The void ratio of the three-dimensional shaping powder is preferably 70% to 98%, more preferably 75% to 97.7%. This makes it possible to give the three-dimensional shaped object 10 particularly excellent mechanical strength. Additionally, this makes it possible to give the three-dimensional shaping powder particularly excellent fluidity and give the composition (three-dimensional shaping composition) 11 comprising the three-dimensional shaping powder particularly excellent fluidity, and to give the three-dimensional shaped object 10 particularly excellent productivity, and also makes it possible to more effectively prevent the occurrence of an undesirable unevenness in the three-dimensional shaped object 10 being manufactured or the like, and to give the three-dimensional shaped object 10 particularly excellent dimensional accuracy. In the present invention, the “void ratio” of the three-dimensional shaping powder refers to the ratio of the sum of the volume of the holes possessed by all particles (particles) constituting the three-dimensional shaping powder and the volume of the voids present between the particles, with respect to the volume of a container of a predetermined volume (for example, 100 mL) in a case where the container is filled with the three-dimensional shaping powder, and is a value presented by {(P₀−P)/P₀}×100, where P (g/cm³) is the bulk density of the three-dimensional shaping powder and P₀ (g/cm³) is the true density of the constituent material of the three-dimensional shaping powder.

The rate of content of the three-dimensional shaping powder in the composition (three-dimensional shaping composition) 11 is preferably 10 mass % to 90 mass %, more preferably 15 mass % to 65 mass %. This makes it possible to impart particularly excellent mechanical strength to the three-dimensional shaped object 10 that is ultimately obtained, while also imparting ample fluidity to the composition (three-dimensional shaping composition) 11.

### Water-Soluble Resin

The composition 11 is one that comprises the water-soluble resin 112 along with the plurality of particles 111.

Comprising the water-soluble resin 112 makes it possible to bind (temporarily fix) the particle 111 to one another (see FIG. 9) at a site of the layer 1 to which the binder solution 12 has not been applied and to effectively prevent any undesirable scattering of the particles and the like. This makes it possible to achieve further improvement in safety for workers and in dimensional accuracy of the three-dimensional shaped object 10 being manufactured.

In a case where the water-soluble resin is included, the effects described above are obtained, but because the particles constituting the layer on the stage would have been temporarily fixed by the water-soluble resin even in the region where the binding part (curing part) is not formed, a problem emerges in a case where the stage is moved in a relative fashion in the state where the side surface support part is in contact with the layer on the stage, in that not only near the section of contact with the side surface support part but also a wider range is susceptible to disturbance of the layer caused by sliding resistance. By contrast, in the present invention, the occurrence of such a problem can be reliably prevented because the configuration is such that the side surface support part is spaced apart from the side surface of the layer on the stage when the stage moves relative to the side surface support part. As such, the effects of the present invention are more prominently exerted in a case where the composition is one that comprises a water-soluble resin.

In a case where the particles 111 have undergone the hydrophobic treatment, then even in a case where the water-soluble resin 112 is included, the water-soluble resin 112 can be effectively prevented from ending up entering into the holes 1111 of the particles 111. For this reason, the function of the water-soluble resin 112 in temporarily fixing the particles 111 to one another is reliably exhibited, and it is also possible to more reliably prevent the occurrence of a problem where the water-soluble resin 112 ends up entering into the holes 1111 of the particles 111 in advance and thereby makes it impossible to ensure space for the binding agent 121 to enter.

It suffices for the water-soluble resin 112 to be one that is at least partially soluble in water, but, for example, the solubility to water (mass that is soluble in 100 g of water) at 25° C. is preferably 5 (g/100 g water) or higher, more preferably 10 (g/100 g water) or higher.

Examples of the water-soluble resin 112 include synthetic polymers such as polyvinyl alcohol (PVA), polyvinylpyrrolidone (PVP), polycaprolactamdiol, sodium polyacrylate, polyacrylamide, modified polyamide, polyethylenimine, polyethylene oxide, and random copolymer of ethylene oxide and propylene oxide; natural polymers such as corn starch, mannan, pectin, agar, alginic acid, dextran, glue, and gelatin; and semisynthetic polymers such as carboxymethyl cellulose, hydroxyethyl cellulose, oxidized starch and modified starch; it would also be possible to use one species selected from these or a combination of two or more species selected from these.

Specific examples of water-soluble resin products include methylcellulose (Shin-Etsu Chemical: “Metolose SM-15”), hydroxyethyl cellulose (Fuji Chemical Co.: “AL-15”), hydroxypropyl cellulose (Nippon Soda: “HPC-M”), carboxymethyl cellulose (Nichirin Chemical: “CMC-30”), sodium starch phosphate ester (I) (Matsutani Chemical Industry: “Hosuta 5100”), polyvinylpyrrolidone (Tokyo Chemical Industry: “PVP K-90”), methyl vinyl ether/maleic anhydride copolymer (GAF Corp; “AN-139”), polyacrylamide (Wako Pure Chemical Industries), modified polyamide (modified nylon) (manufactured by Toray Industries: “AQnylon”), polyethylene oxide (Steel Chemical: “PEO-1”, Meisei Chemical Works: “Alkox”), ethylene oxide and propylene oxide random copolymer (Meisei Chemical Works: “Alkox EP”), sodium polyacrylate (Wako Pure Chemical Industries), and carboxyvinyl polymer/cross-linked water-soluble acrylic resin (Sumitomo Seika Chemicals: “Aqupec”).

Of these, a case where the water-soluble resin 112 is a polyvinyl alcohol makes it possible to give the three-dimensional shaped object 10 particularly excellent mechanical strength. Also, adjusting the degree of saponification and degree of polymerization makes it possible to more favorably control the properties of the water-soluble resin 112 (for example, the water solubility, water resistance, and the like) and the properties of the composition 11 (for example, the viscosity, the fixing force of the particles 111, the wetting properties, and the like). For this reason, the manufacture of a diverse range of three-dimensional shaped objects 10 can be accommodated. A polyvinyl alcohol also offers lower cost and more stable supply among the variety of water-soluble resins. For this reason, the three-dimensional shaped object 10 can be stably manufactured while production costs are also being kept low.

In a case where the water-soluble resin 112 is one that comprises a polyvinyl alcohol, then the degree of saponification of that polyvinyl alcohol is preferably 85 to 90. This makes it possible to curb any decrease in the solubility of the polyvinyl alcohol to water. It is therefore possible to more effectively suppress any decrease in the adhesion between adjacent layers 1 in a case where the composition 11 is one that comprises water.

In the case where the water-soluble resin 112 is one that comprises a polyvinyl alcohol, then the degree of polymerization of that polyvinyl alcohol is preferably 300 to 1,000. This makes it possible to impart particularly excellent mechanical strength to each of the layers 1 and impart particularly excellent adhesion between the adjacent layers 1 in the case where the composition 11 is one that comprises water.

The following effects are obtained in a case where the water-soluble resin 112 is polyvinylpyrrolidone (PVP). Namely, polyvinylpyrrolidone has excellent adhesion to a variety of materials such as glasses, metals, and plastics, and therefore it is possible to impart particularly excellent strength and stability of shape to the portions of the layers 1 where the binder solution 12 is not applied, and to impart particularly excellent dimensional accuracy to the three-dimensional shaped object 10 that is ultimately obtained. Also, polyvinylpyrrolidone exhibits high solubility to a variety of organic solvents, and therefore in a case where the composition 11 comprises an organic solvent, the composition 11 can be given particularly excellent fluidity, layers 1 with which any undesirable variance in the thickness has been more effectively prevented can be formed, and the three-dimensional shaped object 10 that is ultimately obtained can be given particularly excellent dimensional accuracy. Moreover, polyvinylpyrrolidone exhibits high solubility to water, as well, and therefore it is possible to easily and reliably remove any of the particles 111 constituting each of the layers 1 that have not been bound by the binding agent 121 in the unbound particle removal step (after the end of shaping). In addition, polyvinylpyrrolidone has an appropriate degree of affinity to the three-dimensional shaping powder, and therefore such entry into the holes 1111 as described earlier is unlikely to occur adequately but the wettability to the surface of the particles 111 is comparatively high. For this reason, the function of temporary fixing as described above can be more effectively exerted. Polyvinylpyrrolidone also has excellent affinity with a variety of coloring agents, and therefore in a case where a binder solution 12 that comprises a coloring agent is used in the binder solution application step, the coloring agent can be effectively prevented from spreading undesirably. When the composition 11 in paste form comprises polyvinylpyrrolidone, bubbles can be effectively prevented from getting trapped in the composition 11, and defects caused by trapping of bubbles can be more effectively prevented from occurring in the layer formation step.

In a case where the water-soluble resin 112 is one that comprises polyvinylpyrrolidone, then the weight-average molecular weight of that polyvinylpyrrolidone is preferably 10,000 to 1,700,000, more preferably 30,000 to 1,500,000. This makes it possible to more effectively exert the functions described above.

In a case where the water-soluble resin 112 is polycaprolactamdiol, then: the composition 11 can be suitably made into the form of pellets; unintended scattering or the like of the particles 111 can be more effectively prevented; the handling properties (ease of handling) of the composition 11 are improved; the safety for workers can be improved, as can the dimensional accuracy of the three-dimensional shaped object 10 being manufactured; and melting at a relatively low temperature is possible, therefore making it possible to curb the energy costs needed to produce the three-dimensional shaped object 10 and making it possible to endow the three-dimensional shaped object 10 with adequately superior productivity.

In the case where the water-soluble resin 112 is one that comprises polycaprolactamdiol, the weight-average molecular weight of this polycaprolactamdiol is preferably 10,000 to 1,700,000, more preferably 30,000 to 1,500,000. This makes it possible to more effectively exert the functions described above.

In the composition 11, it is preferable for the water-soluble resin 112 to take a liquid state (for example, a dissolved state, a molten state, or the like) at least in the layer formation step. This makes it possible to easily and reliably impart even higher uniformity of thickness to the layers 1 that are formed using the composition 11.

### Solvent

In addition to the components described above, the composition 11 may comprise a volatile solvent (not shown in FIG. 9).

This makes it possible to suitably make the composition into a paste, and possible to give the composition 11 stably excellent fluidity and give the three-dimensional shaped object 10 particularly excellent productivity. This is due to the following reasons. Namely, in the present invention, during the formation of the binding part (binder solution application step and curing step), it is preferable to lower the fluidity of the layers formed using the composition in terms of the stability of shape of the layers and of preventing unintended wetting and spreading of the binding solution; in a case where the composition comprises a solvent, removing (evaporating) the solvent makes it possible to lower the fluidity of the layers. By contrast, in a case where, for example, there is melting of the components included in the composition during the layer formation, then lowering the fluidity of the layers formed using the composition necessitates lowering the temperature of the composition (layers), but in general, it is easier and faster to adjust the fluidity by removing the solvent than to adjust the fluidity by adjusting the temperature in this manner. Moreover, with adjustment of the fluidity by adjustment of the temperature, the fluidity of the layers has relatively large fluctuations, making it difficult to stably control the fluidity of the layers, but in a case of adjustment by removal of the solvent, the fluidity of the layers can easily be controlled stably. Moreover, in a case of melting the components included in the composition, it is necessary to repeatedly heat and cool the composition, which necessitates a considerable amount of energy, whereas in a case where a solvent has been used, the amount of energy used can be kept low. As such, it is preferable to use a solvent in terms of energy saving, as well.

Preferably, the solvent is one that dissolves the water-soluble resin 112. This makes it possible to endow the composition 11 with favorable fluidity, and makes it possible to more effectively prevent any unintended variance in the thickness of the layers 1 that are formed using the composition 11. This also makes it possible to cause the water-soluble resin 112 to stick to the particles 111 at higher uniformity across the whole of the layers 1 in formation of the layers 1 in a state from which the solvent has been removed, and makes it possible to more effectively prevent the occurrence of any unintended unevenness of the composition. For this reason, any undesirable variance in the mechanical strength at each of the sites of the three-dimensional shaped object 10 that is ultimately obtained can be more effectively prevented from occurring, and the three-dimensional shaped object 10 can be given a higher reliability. The configuration illustrated in FIG. 9 does not illustrate the solvent, but rather illustrates the water-soluble resin 112 as existing stuck to a part of the outer surface of the particles 111 as though deposited; however, in the case where the solvent is included, then, for example, the water-soluble resin 112 is included in the composition 11 in a dissolved state in the solvent, and this solvent may be present in a state of having wetted the surface (for example, the surface other than the holes 1111 of the particles 111) of the particles 111.

Examples of the solvent constituting the composition 11 include: water; alcohol solvents such as methanol, ethanol, and isopropanol; ketone solvents such as methyl ethyl ketone and acetone; glycol ether solvents such as ethylene glycol monoethyl ether and ethylene glycol monobutyl ether; glycol ether acetate solvents such as propylene glycol 1-monomethyl ether 2-acetate and propylene glycol 1-monomethyl ether 2-acetate; and polyethylene glycol and polypropylene glycol. It would also be possible to use one species selected from these or a combination of two or more species selected from these.

Of these, the composition 11 preferably is one that includes water. This makes it possible to more reliably dissolve the water-soluble resin 112, and makes it possible to impart particularly excellent fluidity to the composition 11 and particularly excellent uniformity of composition to the layers 1 that are formed using the composition 11. Water is also easily removed after the formation of the layers 1, and is unlikely to have any adverse effects even in a case where some water remains in the three-dimensional shaped object. Water is additionally advantageous in terms of being safe for the human body and in terms of environmental issues.

In the case where the composition 11 is one that includes a solvent, the content rate of the solvent in the composition 11 is preferably 5 to 75 mass %, more preferably 35 to 70 mass %. This causes the effects from comprising the solvent as described above to be more prominently exerted, and also makes it possible to easily remove the solvent quickly during the steps of manufacturing the three-dimensional shaped object 10, and therefore is advantageous in terms of improving the productivity of the three-dimensional shaped object 10.

In particular, in a case where the composition 11 is one that includes water as a solvent, the content rate of water in the composition 11 is preferably 20 to 73 mass %, more preferably 50 to 70 mass %. This causes the above such effects to be more prominently exhibited.

### Other Components

The composition 11 may also be one that comprises components other than those described above. Examples of such components could include a polymerization initiator, a polymerization accelerator, a penetration enhancer, a wetting agent (moisturizer), a fixing agent, an anti-mildew agent, an antioxidant, an ultraviolet absorber, a chelating agent, or a pH adjusting agent.

### Binder Solution

The binder solution used in the manufacture of a three-dimensional shaped object in the present invention shall next be described in greater detail.

The binder solution 12 includes at least the binding agent 121.

### Binding Agent

The binding agent 121 need only be one that has the function of binding the particles 111, but preferably is one that is hydrophobic (lipophilic) in a case where particles that have the holes 1111 (as shall be described in greater detail below) and have undergone the hydrophobic treatment are used as the particles 111. This makes it possible to impart high affinity between the binder solution 12 and the particles 111 having undergone the hydrophobic treatment, and when the binder solution 12 is applied to the layer 1, this makes it possible for the binder solution 12 to suitably penetrate into the holes 1111 of the particles 111 having undergone the hydrophobic treatment. As a result, the anchoring effect from the binding agent 121 is suitably exerted, and the three-dimensional shaped object 10 that is ultimately obtained can be given particularly excellent mechanical strength. A hydrophobic binding agent need only have an adequately low affinity for water; in a preferable example, the solubility to water at 25° C. is 1 (g/100 g of water).

Examples of the binding agent 121 could include a thermoplastic resin; a thermocurable resin; a variety of photocurable resins such as a visible light-curable resin (the narrow definition of a photocurable resin) that is cured by light in the visible light range, an ultraviolet curable resin, or an infrared curable resin; or an X-ray curable resin; it would also be possible to use one species selected from these or a combination of two or more species selected from these. Of these, the binding agent 121 is preferably one that comprises a curable resin, in terms of the mechanical strength of the resulting three-dimensional shaped object 10, the productivity of the three-dimensional shaped object 10, and the like. Of the variety of curable resins, an ultraviolet curable resin (polymerizable compound) is especially preferable in terms of the mechanical strength of the resulting three-dimensional shaped object 10, the productivity of the three-dimensional shaped object 10, the storage stability of the binder solution 12, and the like.

Preferably used as an ultraviolet ray-curable resin (polymerizable compound) is one with which an addition polymerization or ring-opening polymerization is initiated by radical species or cation species or the like produced from a photopolymerization initiator by irradiation with ultraviolet rays, thus creating a polymer. Manners of polymerization in addition polymerization include radical, cationic, anionic, metathesis, and coordination polymerization. Manners of polymerization in ring-opening polymerization include cationic, anionic, radical metathesis, and coordination polymerization.

Examples of addition polymerizable compounds include compounds that have at least one ethylenically unsaturated double bond. Compounds that have at least one, preferably two terminal ethylenically unsaturated bonds can be preferably used as an addition polymerizable compound.

Ethylenically unsaturated polymerizable compounds have the chemical form of monofunctional polymerizable compounds and polyfunctional polymerizable compounds, or mixtures thereof. Examples of monofunctional polymerizable compounds include unsaturated carboxylic acids (for example, acrylic acid, methacrylic acid, itaconic acid, crotonic acid, isocrotonic acid, maleic acid, and the like) or esters or amides thereof. An ester of an unsaturated carboxylic acid and an aliphatic polyhydric alcohol compound or an amide of an unsaturated carboxylic acid and aliphatic polyvalent amine compound is used as a polyfunctional polymerizable compound.

It would also be possible to use: a product of an addition reaction between an isocyanate or an epoxy and an unsaturated carboxylic acid ester or amide that has a nucleophilic substituent such as a hydroxyl group, an amino group, or a mercapto group; a product of a dehydration condensation reaction with a carboxylic acid; or the like. It would also be possible to use: the product of an addition reaction between an unsaturated carboxylic acid ester or amide having an electrophilic substituent group such as an isocyanate group or an epoxy group and an alcohol, amine, or thiol; or the product of a substitution reaction between an unsaturated carboxylic acid ester or amide having a leaving group substituent such as a halogen group or a tosyloxy group and an alcohol, amine, or thiol.

A (meth)acrylic acid ester is representative as a specific example of a radical polymerizable compound that is the ester of an unsaturated carboxylic acid and an aliphatic polyhydric alcohol compound; either a monofunctional one or a polyfunctional one could be used.

Specific examples of monofunctional (meth)acrylates include tolyloxyethyl (meth)acrylate, phenyloxyethyl (meth)acrylate, cyclohexyl (meth)acrylate, ethyl (meth)acrylate, methyl (meth)acrylate, isobornyl (meth)acrylate, and tetrahydrofurfuryl (meth)acrylate.

Specific examples of bifunctional (meth)acrylates include ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexanediol di(meth)acrylate, tetraethylene glycol di(meth)acrylate, pentaerythritol di(meth)acrylate, and dipentaerythritol di(meth)acrylate.

Specific examples of trifunctional (meth)acrylates include trimethylol propane tri(meth)acrylate, trimethylol ethane tri(meth)acrylate, trimethylolpropane alkylene oxide-modified tri(meth)acrylate, pentaerythritol tri(meth)acrylate, dipentaerythritol tri(meth)acrylate, trimethylol propane tri((meth)acryloyloxypropyl) ether, isocyanuric acid alkylene oxide-modified tri(meth)acrylate, propionic acid dipentaerythritol tri(meth)acrylate, tri((meth)acryloyloxyethyl) isocyanurate, hydroxypivalaldehyde-modified dimethylol propane tri(meth)acrylate, and sorbitol tri(meth)acrylate.

Specific examples of tetrafunctional (meth)acrylates include pentaerythritol tetra(meth)acrylate, sorbitol tetra(meth)acrylate, ditrimethylol propane tetra(meth)acrylate, propionic acid dipentaerythritol tetra(meth)acrylate, and ethoxylated pentaerythritol tetra(meth)acrylate.

Specific examples of pentafunctional (meth)acrylates) include sorbitol penta(meth)acrylate, and dipentaerythritol penta(meth)acrylate.

Specific examples of hexafunctional (meth)acrylates include dipentaerythritol hexa(meth)acrylate, sorbitol hexa(meth)acrylate, phosphazene alkylene oxide-modified hexa(meth)acrylate, and captolactone-modified dipentaerythritol hexa(meth)acrylate.

Examples of polymerizable compounds other than (meth)acrylates include itaconic acid esters, crotonic acid esters, isocrotonic acid esters, and maleic acid esters.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetradicrotonate.

Examples of isocrotonic acid esters include ethylene glycol diisocrotonate, pentaerythritol diisocrotonate, and sorbitol tetraisocrotonate.

Examples of maleic acid esters include ethylene glycol dimaleate, triethylene glycol dimaleate, pentaerythritol dimaleate, and sorbitol tetramaleate.

Examples of other esters that can be used also include: the aliphatic alcohol esters disclosed in Japanese Examined Patent Publication 46-27926, Japanese Examined Patent Publication 51-47334, and Japanese Unexamined Patent Publication 57-196231; those having an aromatic backbone disclosed in Japanese Unexamined Patent Publication 59-5240, Japanese Unexamined Patent Publication 59-5241, and Japanese Unexamined Patent Publication 2-226149; and the one containing an amino group disclosed in Japanese Unexamined Patent Publication 1-165613.

Specific examples of monomers of amides of unsaturated carboxylic acids and aliphatic polyvalent amine compounds include methylene bisacrylamide, methylenebismethacrylamide, 1,6-hexamethylene bisacrylamide, 1,6-hexamethylene bismethacrylamide, diethylene triamine trisacrylamide, xylylene bisacrylamide, and xylylene bismethacrylamide.

Another example of a preferable amide monomer would be the one having a cyclohexylene structure disclosed in Japanese Examined Patent Publication 54-21726.

Urethane-based addition polymerizable compounds manufactured using an addition reaction between an isocyanate and a hydroxyl group are also favorable, and a specific example thereof could be a vinyl urethane compound containing two or more polymerizable vinyl groups in a molecule obtained by adding a vinyl monomer containing a hydroxyl group represented in formula (1) below to a polyisocyanate compound having two or more isocyanate groups in one molecule, as is disclosed in Japanese Examined Patent Publication 48-41708.

CH₂═C(R¹)COOCH₂CH(R²)OH (1)

(where R¹ and R² in the formula each independently indicate an H or CH₃)

In the present invention, a cationic ring-opening polymerizable compound having one or more cyclic ether groups such as an epoxy group or an oxetane group in the molecule can be favorably used as an ultraviolet ray-curable resin (polymerizable resin).

Examples of cationic polymerizable compounds include curable compounds comprising a ring-opening polymerizable group, among which heterocyclic group-containing curable compounds are particularly preferable. Examples of such curable compounds include an epoxy derivative, an oxetane derivative, a tetrahydrofuran derivative, a cyclic lactone derivative, a cyclic carbonate derivative, an oxazoline derivative, or other such cyclic imino ethers, or vinyl ethers; of these, epoxy derivatives, oxetane derivatives, and vinyl ethers are preferable.

Examples of preferable epoxy derivatives include monofunctional glycidyl ethers, polyfunctional glycidyl ethers, monofunctional alicyclic epoxies, and polyfunctional alicyclic epoxies.

Specific compounds for glycidyl ethers can be illustratively exemplified by diglycidyl ethers, (for example, ethylene glycol diglycidyl ether, bisphenol A diglycidyl ether, and the like), trifunctional or higher glycidyl ethers (for example, trimethylol ethane triglycidyl ether, trimethylol propane triglycidyl ether, glycerol triglycidyl ether, triglycidyl trishydroxyethyl isocyanurate, or the like), tetrafunctional or higher glycidyl ethers (for example, sorbitol tetraglycidyl ether, pentaerythritol tetraglycyl ether, cresol novolac resin polyglycidyl ether, phenolnovolac resin polyglycidyl ether, and the like), alicyclic epoxies (for example, Celloxide 2021P, Celloxide 2081, Epolead GT-301, and Epolead GT-401 (Daicel Chemical Industries)), EHPE (Daicel Chemical Industries), phenol novolac resin polycyclohexyl epoxy methyl ether or the like), and oxetanes (for example, OX-SQ, PNOX-1009 (Toagosei), and the like).

As a polymerizable compound, an alicyclic epoxy derivative could be preferably used. An “alicyclic epoxy group” is a term for a moiety obtained when a double bond of a cycloalkene group such as a cyclopentene group or cyclohexene group is epoxidized with a suitable oxidizing agent such as hydrogen peroxide or a peroxy acid.

Preferable alicyclic epoxy compounds include polyfunctional alicyclic epoxies having two or more cyclohexene oxide groups or cyclopentene oxide groups in one molecule. Specific examples of alicyclic epoxy compounds include 4-vinylcyclohexene dioxide, (3,4-epoxycyclohexyl)methyl-3,4-epoxycyclohexyl carboxylate, di(3,4-epoxycyclohexyl) adipate, di(3,4-epoxycyclohexylmethyl) adipate, bis(2,3-epoxycyclopentyl) ether, di(2,3-epoxy-6-methylcyclohexylmethyl)adipate, and dicyclopentadiene dioxide.

A glycidyl compound having a normal epoxy group without an alicyclic structure in the molecule could be used either independently or in combination with an aforementioned alicyclic epoxy compound.

Examples of such normal glycidyl compounds could include glycidyl ether compounds and glycidyl ester compounds, but it is preferable to use a glycidyl ether compound in combination.

Specific examples of glycidyl ether compounds include: an aromatic glycidyl ether compound such as 1,3-bis(2,3-epoxypropyloxy) benzene, a bisphenol A epoxy resin, a bisphenol F epoxy resin, a phenol novolac epoxy resin, a cresol novolac epoxy resin, and a trisphenol methane epoxy resin; and an aliphatic glycidyl ether compound such as 1,4-butanediol glycidyl ether, glycerol triglycidyl ether, propylene glycol diglycidyl ether, and trimethylol propane tritriglycidyl ether. Examples of a glycidyl ester could include a glycidyl ester of linoleic acid dimers.

As a polymerizable compound, it would be possible to use a compound that has an oxetanyl group, which is a four-membered cyclic ether (this compound also being called simply an “oxetane compound” below). An oxetanyl group-containing compound is a compound that has one or more oxetanyl groups in one molecule.

The content rate of the binding agent in the binder solution 12 is preferably 80 mass % or higher, more preferably 85 mass % or higher. This makes it possible to impart particularly excellent mechanical strength to the three-dimensional shaped object 10 that is ultimately obtained.

### Other Components

The binder solution 12 may also comprise components other than those described above. Examples of such components can include a variety of coloring agents such as a pigment or a dye, a dispersant, a surfactant, a polymerization initiator, a polymerization accelerator, a solvent, a penetration enhancer, a wetting agent (moisturizer), a fixing agent, an anti-mildew agent, a preservative, an antioxidant, an ultraviolet absorber, a chelating agent, a pH adjusting agent, a thickener, a filler, an aggregation inhibitor, or a defoamer.

In particular, when the binder solution 12 comprises a coloring agent, this makes it possible to obtain a three-dimensional shaped object 10 that has been colored to a color corresponding to the color of the coloring agent.

In particular, using a pigment as the coloring agent makes it possible to endow the binder solution 12 and the three-dimensional shaped object 10 with favorable light resistance. For the pigment, it would be possible to use an inorganic pigment or an organic pigment.

Examples of inorganic pigments include: carbon blacks (CI Pigment Black 7) such as furnace black, lamp black, acetylene black and channel black; iron oxide, or titanium oxide; from which one kind can be selected for use, or two or more kinds can be combined for use.

Of these inorganic pigments, titanium oxide is preferable because of the preferable white color exhibited thereby.

Examples of inorganic pigments include: an azo pigment such as an insoluble azo pigment, a condensed azo pigment, azo lake, or chelate azo pigment; a polycyclic pigment such as a phthalocyanine pigment, a perylene or perynone pigment, an anthraquinone pigment, a quinacridone pigment, a dioxane pigment, a thioindigo pigment, an isoindolinone pigment, or a quinophthalone pigment; dye chelate (for example, a basic dye chelate or an acidic dye chelate, or the like); a color lake (a basic dye lake or an acidic dye lake); a nitro pigment; a nitroso pigment; aniline black; or a daylight fluorescent pigment; it would also be possible to use one species selected from these or a combination of two or more species selected from these.

More specifically, examples of carbon blacks that are used as pigments for the color black include: No. 2300, No. 900, MCF88, No. 33, No. 40, No. 45, No. 52, MA7, MA8, MA 100, No. 2200B, and the like (Mitsubishi Chemical); Raven 5750, Raven 5250, Raven 5000, Raven 3500, Raven 1255, Raven 700, and the like (Carbon Columbia); Regal 400R, Regal 330R, Regal 660R, Mogul L, Monarch 700, Monarch 800, Monarch 880, Monarch 900, Monarch 1000, Monarch 1100, Monarch 1300, Monarch 1400, and the like (Cabot Japan); and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, Special Black 4 (Degussa).

Examples of pigments for the color white include CI Pigment White 6, 8, and 21.

Examples of pigments for the color yellow include CI Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of pigments for the color magenta include CI Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, or CI Pigment Violet 19, 23, 32, 33, 36, 38, 43, and 50.

Examples of pigments for the color cyan include CI Pigment Blue 1, 2, 3, 15, 15:1, 15:2, 15:3, 15:34, 15:4, 16, 18, 22, 25, 60, 65, 66, and CI Vat Blue 4 and 60.

Examples of pigments other than those mentioned above include CI Pigment Green 7 and 10, CI Pigment Brown 3, 5, 25, and 26, and CI Pigment Orange 1, 2, 5, 7, 13, 14, 15, 16, 24, 34, 36, 38, 40, 43, and 63.

In a case where the binder solution 12 is one that comprises a pigment, then the mean particle size of the pigment is preferably 300 nm or less, more preferably 50 nm to 250 nm. This makes it possible to impart particularly excellent discharge stability to the binder solution 12 and particularly excellent dispersion stability to the pigment in the binder solution 12, and also makes it possible to form images of better image quality.

Examples of dyes include an acidic dye, a direct dye, a reactive dye, or a basic dye; it would also be possible to use one species selected from these or a combination of two or more species selected from these.

Specific examples of dyes include CI Acid Yellow 17, 23, 42, 44, 79, and 142, CI Acid Red 52, 80, 82, 249, 254, and 289, CI Acid Blue 9, 45, and 249, CI Acid Black 1, 2, 24, and 94, CI Food Black 1 and 2, CI Direct Yellow 1, 12, 24, 33, 50, 55, 58, 86, 132, 142, 144, and 173, CI Direct Red 1, 4, 9, 80, 81, 225, and 227, CI Direct Blue 1, 2, 15, 71, 86, 87, 98, 165, 199, and 202, CI Direct Black 19, 38, 51, 71, 154, 168, 171, and 195, CI Reactive Red 14, 32, 55, 79, and 249, and CI Reactive Black 3, 4, and 35.

In a case where the binder solution 12 comprises a coloring agent, then the rate of content of the coloring agent in the binder solution 12 is preferably 1 mass % to 20 mass %. This produces particularly excellent masking and color reproducibility.

In particular, in a case where the binder solution 12 is one that comprises titanium oxide as a coloring agent, then the rate of content of the titanium oxide in the binder solution 121 is preferably 12 mass % to 18 mass %, more preferably 14 mass % to 16 mass %. This produces particularly excellent masking.

In a case where the binder solution 12 comprises a pigment, then the pigment can be given more favorable dispersibility when a dispersing agent is also contained. Though not particularly limited, examples of dispersing agents include dispersing agents that are commonly used to prepare pigment dispersions, such as polymeric dispersing agents. Specific examples of polymeric dispersing agents include those composed mainly of one or more species from among polyoxyalkylene polyalkylene polyamine, vinyl-based polymers and copolymers, acrylic polymers and copolymers, polyester, polyamide, polyimide, polyurethane, amino-based polymers, silicon-containing polymers, sulfur-containing polymers, fluorine-containing polymers, and epoxy resins. Examples of commercially available forms of polymeric dispersing agents include Ajinomoto Fine-Techno's Ajisper series, the Solsperse series (Solsperse 36000 and the like) available from Noveon, BYK's Disperbyk series, and Kusumoto Chemicals' Disparlon series.

When the binder solution 12 comprises a surfactant, the three-dimensional shaped object 10 can be given better abrasion resistance. Though not particularly limited, examples of what can be used as a surfactant include polyester-modified silicone or polyether-modified silicone serving as a silicone-based surfactant; of these, it is preferable to use polyether-modified polydimethylsiloxane or polyester-modified polydimethylsiloxane. Specific examples of surfactants include BYK-347, BYK-348, and BYK-UV 3500, 3510, 3530, and 3570 (which are trade names of BYK).

The binder solution 12 may also be one that comprises a solvent. This makes it possible to favorably adjust the viscosity of the binder solution 12, and makes it possible to give the binder solution 12 particularly excellent stability of discharge by inkjet format even when the binder solution 12 comprises high-viscosity components.

Examples of solvents include: (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, isopropyl acetate, n-butyl acetate, and isobutyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; and alcohols such as ethanol, propanol, and butanol; it would also be possible to use one species selected from these or a combination of two or more species selected from these.

The viscosity of the binder solution 12 is preferably 10 to 30 mPa·s, more preferably 15 to 25 mPa·s. This makes it possible to give the binder solution 12 particularly excellent stability of discharge by inkjet. In the present specification, “viscosity” refers to a value measured at 25° C. using an E-type viscometer (Visconic ELD made by Tokyo Keiki), unless conditions are otherwise specified. A plurality of types of binder solution 12 may also be used in the manufacture of the three-dimensional shaped object 10.

For example, a binder solution 12 (color ink) comprising a coloring agent and a binder solution 12 (clear ink) not comprising a coloring agent may be used. This makes it possible, for example, to use the binder solution 12 that comprises the coloring agent as a binder solution 12 applied to a region where the color tone is affected in terms of the outer appearance of the three-dimensional shaped object 10 and to use the binder solution 12 that does not comprise a coloring agent as a binder solution 12 applied to a region where the color tone is not affected in terms of the outer appearance of the three-dimensional shaped object 10. A plurality of types of binder solution 12 may be used on combination so as to provide, in the three-dimensional shaped object 10 that is ultimately obtained, a region (coating layer) that is formed using the binder solution 12 not comprising a coloring agent to an outer surface of a region formed using the binder solution 12 comprising a coloring agent.

In another example, a plurality of types of binder solution 12 comprising coloring agents of different compositions may also be used. This makes it possible to broaden the range of color reproduction that can be rendered, using combinations of these binder solutions 12.

In a case where a plurality of types of binder solution 12 are used, then preferably at least a cyan binder solution 12, a magenta binder solution 12, and a yellow binder solution 12 are used. This makes it possible to further broaden the range of color reproduction that can be rendered, using combinations of these binder solutions 12.

Also using a white binder solution 12 and a binder solution 12 of another color in combination produces, for example, the following effects. Namely, it is possible to endow the three-dimensional shaped object 10 that is ultimately obtained with a first region to which the white binder solution 12 is applied and a region (second region) which overlaps with the first region and to which a binder solution 12 of a color other than white is applied, provided closer to the outside surface than the first region. This makes it possible for the first region to which the white binder solution 12 is applied to exert masking, and makes it possible to further increase the color saturation of the three-dimensional shaped object 10.

### Three-Dimensional Shaped Object

A three-dimensional shaped object of the present invention can be manufactured using the method of manufacture and apparatus for manufacturing a three-dimensional shaped object as described above. This makes it possible to provide a three-dimensional shaped object which has excellent dimensional accuracy and with which the occurrence of defects has been effectively prevented.

Use of the three-dimensional shaped object of the present invention is not particularly limited, but examples include an ornamental article or presented article such as a doll or figure, a medical device such as an implant, and the like.

The three-dimensional shaped object of the present invention may also be applied to prototypes, mass-produced goods, and custom-made goods.

A preferred embodiment of the present invention has been described above, but the present invention is in no way limited thereto.

For example, the embodiment illustrated in FIGS. 1 to 4 representatively describes a configuration in which the stage is lowered, but in the method of manufacture of the present invention, it suffices for the stage and the side surface support part to move in a relative fashion in the direction of layering of the layers in the layering direction movement step; for example, the configuration may be such that the side surface support part moves upward.

Also, the embodiment described above centers on a case where the entirety of the side surface support part for supporting the side surface of the layers is spaced apart from the side surface of the layer when the stage is moving relative to the side surface support part in the Z-direction (up-down direction), but it suffices to configure so that at least a part of the side surface support part is spaced apart from the side surface of the layers when the stage is moving relative to the side surface support part in the up-down direction. Possible examples include configuring so that only a portion of the side surface support part that is arranged on both sides of the first direction, which is the relative movement direction of the flattening part, is spaced apart from the side surface of the layer.

Also, a roller or the like may be used as the flattening part, instead of the squeegee described above.

The apparatus for manufacturing a three-dimensional shaped object in the present invention may be provided with a recover mechanism (not shown) for recovering any of the composition supplied from the composition supply part that is not used in the formation of the layers. This makes it possible to supply an ample amount of the composition while also preventing accumulation of any surplus composition in the layer formation part, and therefore makes it possible to more stably manufacture the three-dimensional shaped object while also more effectively preventing the occurrence of defects in the layers. The recovered composition can also be used again in the manufacture of the three-dimensional shaped object, and therefore can contribute to reducing the costs of manufacturing the three-dimensional shaped object, thus being also preferable in terms of conserving resources.

The apparatus for manufacturing a three-dimensional shaped object in the present invention may be provided with a recovery mechanism for recovering the composition that is removed in the unbound particle removal step.

The embodiment above described the binding part as being formed for all of the layers, but there may also be layers where the binding part is not formed. For example, the layer formed directly atop the stage may not receive the formation of a binding part, instead functioning as a sacrificial layer.

The embodiment described above focused on a case where the binder solution application step is carried out by inkjet, but the binder solution application step may also be carried out using another method (for example, another printing method).

In the method of manufacture of the present invention, the side surface support part spacing step and side surface support part abutment step may be carried out for at least some layers of the plurality of layers that constitute the three-dimensional shaped object, or the side surface support part spacing step and side surface support part abutment step may be carried out for all of the layers.

The embodiment above described the curing step, in addition to the layer formation step and the binder solution application step, as also being carried out repeatedly along with the layer formation step and the binder solution application step, but the curing step need not be carried out repeatedly. For example, a laminate provided with a plurality of layers that are not cured may be formed first and then followed by curing en masse.

The embodiment above describes the side surface support part spacing step, the layering direction movement step, and the side surface support part abutment step as being carried out on the layers after the binder solution application step and the binding step, but these steps may be carried out at any time, provided that the steps be carried out after the first layer formation step and before the second layer formation step.

In the method of manufacture of the present invention, a pre-treatment step, an intermediate treatment step, and a post-treatment step may be carried out as needed.

Examples of the pre-treatment step include a step for cleaning the stage, and the like.

In one example of an intermediate step in a case where the three-dimensional shaping composition takes the form of pellets, there may be a step (water-soluble resin curing step) for stopping the heating or the like between the layer formation step and the binder solution application step. This causes the water-soluble resin to take a solid state and makes it possible to obtain the layers with stronger binding strength between the particles. In another example in a case where the three-dimensional shaping composition comprises a solvent component (dispersing medium) such as water, there may be solvent component removal step for removing this solvent component between the layer formation step and the binder solution application step. This makes it possible to carry out the layer formation step in a more unencumbered manner, and makes it possible to more effectively prevent an unintended variance in the thickness of the layers being formed. As a result, a three-dimensional shaped object 10 having better dimensional accuracy can be manufactured at higher productivity.

Examples of post-treatment steps would include a cleaning step, a shape adjustment step for deburring and the like, a coloring step, a cover layer formation step, or a binding agent curing completion step for carrying out a light irradiation treatment or heating treatment in order to ensure curing of any binding agent that is not yet cured.

The embodiment described above centered on a method that has the binder solution application step and the curing step (binding step), but in the example of a case where the binder solution comprises a thermoplastic resin as the binding agent, then there is no need to provide the curing step (binding step) after the binder solution application step (it being possible to have the binder solution application step also serve as the binding step). In such a case, the apparatus for manufacturing a three-dimensional shaped object need not be provided with an energy ray irradiating part (curing part).

The embodiment above described the example illustrated in FIGS. 6 and 7 as the shape of the constituent members of the side surface support part provided to the apparatus for manufacturing a three-dimensional shaped object, but in the present invention, the shape of the constituent members of the side surface support part is in no way limited thereto, and may be any shape.

Moreover, the embodiment above representatively describes a case where the side surface support part is constituted of four members so as to correspond to the number of sides possessed by the stage, but the number of members constituting the side surface support part is not particularly limited.

The embodiment above described a case where the members constituting the side surface support part have a surface at which there is close contact with one another in the state where the side surface support part is abutted against the layer on the stage, but there is no limitation to being of such a configuration in the present invention.

Also, the embodiment above described the flattening part as moving over the stage, but the stage may instead be moved, thus flattening by causing the positional relationship between the stage and the squeegee to change.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An apparatus for manufacturing a three-dimensional shaped object adapted to manufacture a three-dimensional shaped object by successively laying down layers using a composition in paste form including particles, the apparatus for manufacturing a three-dimensional shaped object comprising:
a stage where the composition is applied and where the layers are formed; and
a side surface support part arranged at a side surface of the stage,
the stage and the side surface support part being configured and arranged so that the stage moves relative to the side surface support part in a direction of layering of the layers, at least a part of the side surface support part being spaced apart from the stage when the stage is moving relative to the side surface support part in the direction of layering of the layers.

2. The apparatus for manufacturing a three-dimensional shaped object as set forth in claim 1, wherein
the stage is configured and arranged to move in the direction of layering of the layers.

3. The apparatus for manufacturing a three-dimensional shaped object as set forth in claim 1, wherein
the side surface support part is configured and arranged to move in the direction of layering of the layers.

4. The apparatus for manufacturing a three-dimensional shaped object as set forth in claim 1, further comprising
a flattening part configured and arranged to move over the stage in a manner relative to the stage and to flatten the composition applied to the stage to form the layers, wherein
a portion of the side surface support part arranged on both sides of a first direction, which is a relative movement direction of the flattening part, is spaced apart from side surfaces of the layers.

5. The apparatus for manufacturing a three-dimensional shaped object as set forth in claim 4, wherein
a portion of the side surface support part arranged on both sides of a second direction orthogonal to the first direction is also spaced apart from the side surfaces of the layers.

6. The apparatus for manufacturing a three-dimensional shaped object as set forth in claim 1, further comprising
a heating part configured and arranged to heat the side surface support part.

7. The apparatus for manufacturing a three-dimensional shaped object as set forth in claim 1, further comprising
a binder solution applying part configured and arranged to apply a binder solution for binding the particles.

8. The apparatus for manufacturing a three-dimensional shaped object as set forth in claim 7, further comprising
an ultraviolet ray irradiating part, wherein
the binder solution includes an ultraviolet curable resin.

9. The apparatus for manufacturing a three-dimensional shaped object as set forth in claim 8, wherein
the side surface support part is configured and arranged to absorb ultraviolet rays.

10. A method of manufacturing a three-dimensional shaped object comprising manufacturing the three-dimensional shaped object using the apparatus for manufacturing a three-dimensional shaped object as set forth in claim 1.

11. A method of manufacturing a three-dimensional shaped object adapted to carry out a layer forming step a plurality of times to form layers using a composition in paste form including particles to form a three-dimensional shaped object, the method of manufacturing a three-dimensional shaped object comprising:
where any one of a plurality of the layers is a first layer, a step for forming the first layer is a first layer formation step, a layer that is formed directly atop the first layer is a second layer, and a step for forming the second layer is a second layer formation step,
between the first layer formation step and the second layer formation step,
spacing a side surface support part for supporting side surfaces of the layers apart from the side surfaces of the layers;
moving a stage where the layers are formed and the side surface support part in a relative manner in a direction of layering of the layers; and
abutting the side surface support part against the side surfaces of the layers.

12. The method of manufacturing a three-dimensional shaped object as set forth in claim 11, further comprising
applying a binder solution for binding the particles onto the layers, between the first layer formation step and the spacing of the side surface support part.

13. A three-dimensional shaped object manufactured using the apparatus for manufacturing a three-dimensional shaped object as set forth in claim 1.
